(19) United States
(12) Patent Application Publication
(10) Pub. No.: US 2025/0205908 A1
(43) Pub. Date: Jun. 26, 2025

(54) MECHANICAL END EFFECTOR

(71) Applicant: Figure AI Inc., Sunnyvale, CA (US)

(72) Inventors: Jake Goldsmith, Sunnyvale, CA (US); Michael Stevens, Sunnyvale, CA (US)

(21) Appl. No.: 19/000,626

(22) Filed: Dec. 23, 2024

Related U.S. Application Data
(60) Provisional application No. 63/614,499, filed on Dec. 22, 2023.
(60) Provisional application No. 63/617,762, filed on Jan. 4, 2024.
(60) Provisional application No. 63/561,315, filed on Mar. 5, 2024.
(60) Provisional application No. 63/573,226, filed on Apr. 2, 2024.
(60) Provisional application No. 63/615,766, filed on Dec. 28, 2023.
(60) Provisional application No. 63/620,633, filed on Jan. 12, 2024.

(51) Int. Cl. B25J 15/10; B25J 9/10

(52) U.S. Cl. CPC B25J 15/10; B25J 9/106

(57) ABSTRACT

A mechanical end effector for a humanoid robot includes a plurality of identical finger assemblies. Each of the finger assemblies is removably connected to a frame. Each of the finger assemblies is fully self-contained and operable independently of every other one of the finger assemblies and independently of every other component connected to the frame. Each of the finger assemblies includes a single electric motor and is configured to be fully operable using only the single electric motor.

### CROSS-REFERENCE TO RELATED APPLICATIONS

This application claims benefit under 35 U.S.C. § 119 of U.S. Provisional Patent Applications Nos. 63/614,499, 63/617,762, 63/561,315, 63/573,226, 63/615,766, 63/620,633 all of which are incorporated herein by reference for any purpose. U.S. patent application Ser. Nos. 18/919,263 and 18/919,274, and U.S. Provisional Patent Application Nos. 63/557,874, 63/626,040, 63/626,105, 63/625,362, 63/625,370, 63/625,381, 63/625,384, 63/625,389, 63/625,405, 63/625,423, 63/625,431, 63/685,856, 63/696,507, 63/696,533, 63/706,768, 63/722,057, and 63/700,749 are all incorporated herein by reference for any purpose.

### TECHNICAL FIELD

This disclosure relates to a mechanical end effector for a robot, specifically a general-purpose humanoid robot. The mechanical end effector includes various assemblies, components contained in the various assemblies, and connections between said components that provide the mechanical end effector with the ability to substantially mimic the movements, capabilities, and configuration of a human hand.

### BACKGROUND

The current workplace landscape is marked by an unparalleled labor shortage, evident in over 10 million unsafe or undesirable jobs within the United States. These positions often encompass tasks in high-risk sectors—such as manufacturing, construction, and materials handling—where human labor faces safety challenges or heightened physical strain. To mitigate this widening labor gap, there is a pronounced need for high-performance robotic systems that can assume responsibility for a variety of demanding, repetitive, or potentially dangerous operations. Consequently, ongoing advancements in robotics research have concentrated on the development of sophisticated, general-purpose humanoid robots, which are specifically engineered to function within environments originally designed for human workers. These general-purpose humanoid robots are equipped with hardware and software architectures optimized for performing diverse tasks with efficiency, accuracy, and reliability in human-centric environments.

In order to fulfill the functional and ergonomic requirements of human-centric environments, general-purpose humanoid robots are commonly outfitted with anthropomorphic features, including two legs, two arms, a torso, and a head or face-like interface that may provide user feedback or display information. Central to this anthropomorphic design philosophy is the mechanical end effector of the robot, which must be able to approximate most of the capability of the human hand in terms of dexterity, strength, and overall versatility. By being able to approximate most of the capability of the human hand, the end effector can more effectively interact with complex, real-world objects, thereby performing functions such as grasping, rotating, and manipulating items with minimal risk of slippage or damage. In addition to providing a high level of dexterity, the design must satisfy operational constraints related to energy consumption, cost efficiency, and mechanical durability. As such, there is a need for a mechanical end effector that can provide humanoid robots with the ability to execute tasks with human-equivalent precision, robustness, and adaptability in dynamic and unpredictable work environments.

### SUMMARY

The present invention is directed at an end effector for a humanoid robot, the end effector comprising a frame, and a finger assembly removably connected to the frame. The finger assembly is comprised of: (i) a worm drive link, (ii) a proximal drive link pivotably coupled to the worm drive link, (iii) a proximal link defining a proximal link recess configured to selectively receive at least a portion of the worm drive link and at least a portion of the main proximal drive link therein, (iv) a medial link pivotably connected to both the proximal link and the proximal drive link and including a medial link recess configured to receive an extent of the medial drive link, and (v) a medial drive link pivotably connected to the medial link by at least one first pivotable coupling located on a first side of a sagittal plane extending through the finger assembly and at least one second pivotable coupling located on a second side of the sagittal plane.

The present invention is also directed at an end effector for a humanoid robot, the end effector comprising a frame, and four finger assemblies, wherein each finger assembly of the four finger assemblies are substantially identical to every other finger assembly of the four finger assemblies, and wherein each finger assembly of the four finger assemblies is removably connected to the frame at a respective point. All of the finger assemblies of the four finger assemblies are located substantially in a single plane, but each finger assembly of the four finger assemblies is angularly offset within the single plane with respect to every other finger assembly of the four finger assemblies. Additionally, the respective points of connection of the four fingers assemblies to the frame are not co-linear, and each finger assembly of the four finger assemblies lacks a mechanical cable configured to actuate any component of the finger assembly.

It should also be understood that the present invention is directed at an end effector for a humanoid robot. The end effector includes a frame, and a plurality of finger assemblies removably connected to the frame. Each finger assembly of the plurality of finger assemblies includes a motor assembly including: (i) a motor having a motor housing, and (ii) a motor shaft having a motor shaft axis, and wherein the motor shaft is configured to rotate about said motor shaft axis. Each of said finger assemblies also includes a worm drive gear coupled to the motor shaft and configured for rotation about: (i) the motor shaft axis, and (ii) a worm drive gear axis, and wherein the motor shaft axis and the worm drive gear axis are coaxial. The finger assemblies further include a worm wheel in geared engagement with the worm drive gear and configured for rotation about a worm wheel axis in response to rotation of the worm drive gear, and wherein the worm wheel axis is perpendicular to the worm drive gear axis. The finger assemblies additionally include a worm drive link having a first end and a second end, and wherein the first end of the worm drive link fixedly connected to the worm wheel so that the worm drive link is configured for rotation about the worm wheel axis in response to rotation of the worm wheel about the worm wheel axis. The finger assemblies also include a proximal drive link having a first end and a second end, and wherein the first end of the proximal drive link pivotably connected to the second end of the worm drive link. Finally, the finger assemblies have a biasing member configured to bias an extent of the proximal drive link toward a first location, and wherein the extent of the proximal drive link is in the first location when the finger assembly is in an uncurled position.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a perspective view of a wrist coupler and a mechanical end effector that is designed to emulate a human left hand, wherein the mechanical end effector includes a plurality of finger assemblies, a thumb assembly, a housing, and electronics for controlling the finger assemblies and the thumb assembly;

FIG. 2 is a perspective view of the wrist coupler and the mechanical end effector of FIG. 1, wherein said wrist coupler is removably secured to a lower extent of a robot arm;

FIG. 3 is a 6 view of the mechanical end effector of FIGS. 1-2;

FIG. 4 is a top or back view of the mechanical end effector of FIGS. 1-2;

FIG. 5 is a right side or thumb view of the mechanical end effector of FIGS. 1-2;

FIG. 6 is a left side or finger view of the mechanical end effector of FIGS. 1-2;

FIG. 7 is a rear view of the mechanical end effector of FIGS. 1-2;

FIG. 8 is a front view of the mechanical end effector of FIGS. 1-2;

FIG. 9 is a cross-sectional view of the mechanical end effector taken along line 9-9 of FIG. 10;

FIG. 10 is a top view of the mechanical end effector of FIGS. 1-2;

FIG. 11 is a perspective view of the mechanical end effector of FIGS. 1-2, wherein an extent of the housing has been removed to show a portion of the components contained within said housing;

FIG. 12 is a bottom view of the mechanical end effector of FIG. 11;

FIG. 13 is a left side view of the mechanical end effector of FIG. 11;

FIG. 14 is a bottom view of the mechanical end effector of FIG. 11, wherein the thumb has been removed to better isolate the finger assemblies and a frame of the mechanical end effector;

FIG. 15 is an upper right perspective view of a figure assembly of the plurality of figure assemblies contained in the mechanical end effector of FIGS. 1-2, wherein said finger assembly is in an open, uncurled, or neutral position;

FIG. 16 is a bottom left perspective view of the figure assembly of FIG. 15;

FIG. 17 is a left side view of the figure assembly of FIG. 15;

FIG. 18 is a front view of the figure assembly of FIG. 15;

FIG. 19 is a rear view of the figure assembly of FIG. 15;

FIG. 20 is a left side view of a portion of the figure assembly of FIG. 15;

FIG. 21 is a top view of the finger assembly of FIG. 15;

FIG. 22 is a bottom view of the finger assembly of FIG. 15;

FIG. 23A is a cross-sectional view of the finger assembly taken along line 23A-23A of FIG. 21;

FIG. 23B is a cross-sectional view of the finger assembly taken along line 23B-23B of FIG. 21;

FIG. 23C is a cross-sectional view of the finger assembly taken along line 23C-23C of FIG. 21;

FIG. 24A is a cross-sectional view of the finger assembly taken along line 24A-24A of FIG. 20;

FIG. 24B is a cross-sectional view of the finger assembly taken along line 24B-24B of FIG. 20;

FIG. 25 is a diagram showing layers of materials contained in the housing of the finger assembly of FIG. 1;

FIG. 26 is an exploded view of the finger assembly of FIG. 15;

FIG. 27 is a perspective view of the finger assembly of FIG. 15, wherein the housing and motor assembly have been removed to show an internal link assembly;

FIG. 28 is a side view of the internal link assembly of FIG. 27;

FIG. 29 is a top view of the internal link assembly of FIG. 27;

FIG. 30 is a front view of the internal link assembly of FIG. 27;

FIG. 31 is a cross-sectional view of the internal link assembly taken along line 31-31 of FIG. 29;

FIG. 32 is a perspective view of a proximal assembly of the finger assembly of FIG. 15, wherein said proximal assembly includes: (i) a proximal housing assembly, (ii) a proximal link assembly, (iii) a worm wheel assembly, and (iv) a printed circuit board;

FIG. 33 is a bottom view of the proximal assembly of FIG. 32;

FIG. 34 is a side view of the proximal assembly of FIG. 32;

FIG. 35 is a perspective view of the proximal link assembly, the worm wheel assembly, and the printed circuit board of FIG. 32;

FIG. 36 is a top view of the proximal link assembly, the worm wheel assembly, and the printed circuit board of FIG. 32;

FIG. 37 is a cross-sectional view of the proximal link assembly, the worm wheel assembly, and the printed circuit board taken along line 37-37 of FIG. 36;

FIG. 38 is a perspective view of a proximal link of the proximal link assembly of FIG. 32;

FIG. 39 is a top view of the proximal link of FIG. 38;

FIG. 40 is a side view of the proximal link of FIG. 38;

FIG. 41 is a perspective view of a proximal drive link assembly of the proximal link assembly of FIG. 32;

FIG. 42 is a side view of the proximal drive link assembly of FIG. 41;

FIG. 43 is a perspective view of a medial assembly of the finger assembly of FIG. 15, wherein said medial assembly includes: (i) a medial housing assembly, and (ii) a medial link assembly;

FIG. 44 is an end view of the medial assembly of FIG. 43;

FIG. 45 is a side view of the medial assembly of FIG. 43;

FIG. 46 is a perspective view of the medial link assembly of FIG. 43;

FIG. 47 is a side view of the medial link assembly of FIG. 46;

FIG. 48 is a top view of a medial link of the medial link assembly of FIG. 46;

FIG. 49 is side view of the medial link of FIG. 48;

FIG. 50 is a perspective view of the medial link of FIG. 48;

FIG. 51 is a perspective view of a medial drive link of the medial link assembly of FIG. 46;

FIG. 52 is a top view of the medial drive link of FIG. 51;

FIG. 53 is a side view of the medial drive link of FIG. 51;

FIG. 54 is a distal link assembly of the finger assembly of FIG. 15;

FIG. 55 is a side view of the distal link assembly of FIG. 54;

FIG. 56 is a top view of a figure assembly of the plurality of figure assemblies contained in the mechanical end effector of FIGS. 1-2, wherein said finger assembly is in closed, curled, or inwardly rotated position; and

FIG. 57 is a cross-sectional view of the figure assembly taken along line 57-57 of FIG. 56.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present disclosure.

While this disclosure includes several embodiments in many different forms, there is shown in the drawings and will herein be described in detail embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts may be performed in a different order. Accordingly, the drawings, flow charts and detailed description are to be regarded as illustrative in nature, not restrictive or limiting.

### A. Introduction

The mechanical end effector 10 disclosed herein may be used as a component of a robot, for example, a versatile humanoid robot. Enabling such a robot to execute general human tasks poses a challenge due to the vast array of potential positions, locations, and states the robot could occupy at any given time in a challenging environment. The multitude of these permutations can be minimized by training the robot system through various methods such as: (i) imitation learning or teleoperation, (ii) supervised learning, (iii) unsupervised learning, (iv) reinforcement learning, (v) inverse reinforcement learning, (vi) regression techniques, or (vii) other established methodologies. To further streamline the vast array of possible positions, locations, and states, reduce manufacturing steps, complexities and costs, minimize components within the robot system, enhance component modularity, and achieve several other advantages that would be apparent to those skilled in the field, two or more components of the end effector can be either: (i) linked, or (ii) fixed to one another. When two or more components are linked or fixed to one another, movement of one of the components results in movement in another one of the components. In contrast to conventional end effectors that fix the medial and distal assemblies to one another, the disclosed finger assembly movably links the medial and distal assemblies to one another. Such linking provides benefits over fixing because it allows for some independent movement of the medial assembly in relation to the distal assembly while still allowing for the movement of the medial assembly to result in movement of the distal assembly. Such linking allows the finger assembly to become underactuated, that is, to retain its ability to flex, curl, or rotate around an object while eliminating the necessity for multiple actuators, motors, or effectors for each finger assembly. Indeed, the disclosed finger assembly includes only one motor that drives linkages that provide three degrees of freedom DoF per finger assembly. Thus, the end effector has a total of 16 DoF.

Unlike conventional end effectors, the end effector 10 disclosed herein may utilize four identical finger assemblies that are aligned in a single plane (Y-Z), while being offset in two other orthogonal planes (X-Y, and X-Z). The use of identical finger assemblies is beneficial because it reduces the number of distinct components, increases modularity, and reduces the cost of the end effector and the overall robot system. In an alternative embodiment, the end effector 10 may utilize two sets of identical finger assemblies (i.e., two finger assemblies in a first set of assemblies and two finger assemblies in a second set of finger assemblies, wherein each finger contained in the first and second sets of finger assemblies are identical).

While the structural configuration of each finger assembly will be discussed in greater detail below, it should be understood that each finger assembly is configured to be a separate component of the end effector that is modular and removably coupled to a frame of the end effector. As such, said finger assembly is swappable (and in certain embodiments hot-swappable) with another finger assembly. The separate, modular, and swappable nature of the finger assemblies means that: (i) pulleys, articulation cables, pneumatic or hydraulic mechanisms may be omitted from the end effector, and (ii) components of the end effector are not located in the wrist, lower arm, or generally outside of each finger assembly. In other words, the motor, PCBs, encoders, and other electronic components needed to actuate each finger assembly may be fully contained within each finger assembly and are not distributed throughout the arm and/or robot. This full containment aspect is desirable because it increases serviceability and thus decreases the cost of ownership and operation of the robot.

While the disclosed finger assemblies in the end effector 10 utilize a single biasing member (e.g., spring), said finger assemblies utilize a direct drive linkage system in order to eliminate the need to use more than one (e.g., multiple) biasing members (e.g., springs) to force the finger assembly to remain in a predefined position (e.g., open, uncurled, or neutral). Eliminating the use of multiple biasing members for this purpose provides a significant benefit over conventional end effectors because it: (i) removes the need for the motor assembly to overcome a significant biasing force applied by multiple biasing members to move the finger assembly, and (ii) increases durability, robustness, and life of the end effector due to the fact that multiple biasing members can rapidly degrade over time.

Additionally, the disclosed direct drive linkages include components that nest within one another. The use of nesting components is beneficial over conventional finger assemblies of end effectors because each link is supported by at least one coupling point on either side of a plane (e.g., sagittal plane) extending through the finger assembly. In other words, each link in the disclosed finger assembly is coupled on multiple sides, not simply coupled on a single side, which increases the durability of the assembly.

The disclosed finger assemblies in the end effector 10 have a proximal assembly that includes: (i) one component that is directly tied to the movement of the motor, and (ii) one component that is not directly tied to the movement of the motor. For example, the movement of the proximal drive link assembly is directly tied to the movement of the motor, while the proximal housing is not directly tied to the movement of the motor. In fact, the proximal assembly utilizes a bearing to allow slippage between the motor and at least the proximal housing when an extent of the proximal assembly has come into contact with a resistance point/surface. This configuration is beneficial over conventional end effectors because it allows a single motor to fully actuate the finger assembly, by allowing specific components within the proximal assembly to stop moving while the motor continues to drive other components.

Finally, the end effector 10 disclosed herein may lack several components typically found in conventional end effectors. For example, the disclosed end effector 10 lacks pulleys, articulation cables, components configured to allow the fingers to abduct or spread from one another, more than one motor per finger assembly, force sensors, and other components typically found in conventional end effectors. Eliminating these components reduces cost and complexity, while increasing modularity, serviceability, and durability. Other benefits of the disclosed end effector 10 and its various assemblies and components should be apparent to one of skill in the art based on this disclosure and the accompanying figures.

### B. End Effector 10

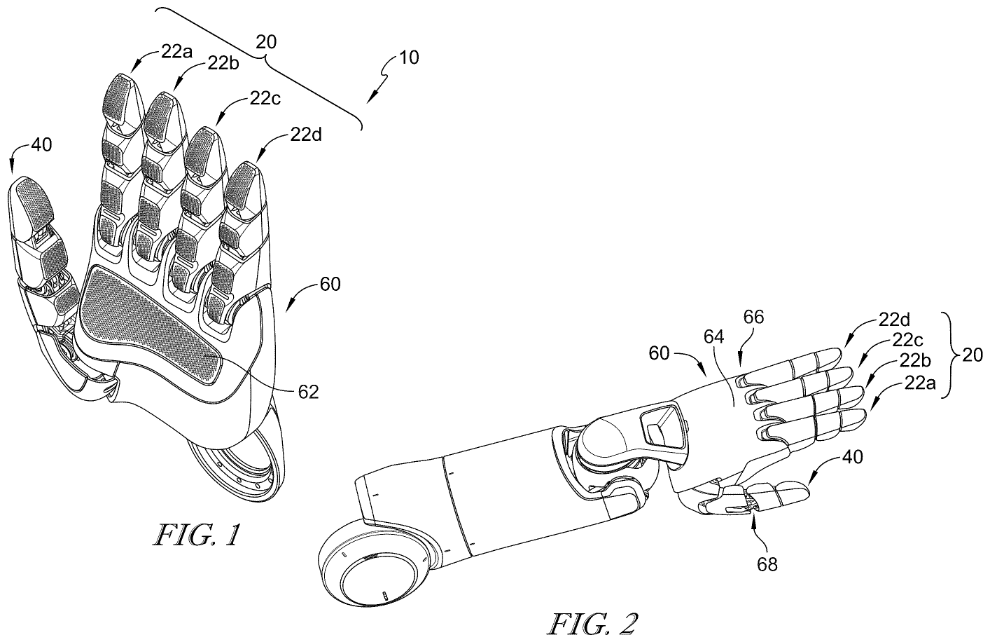

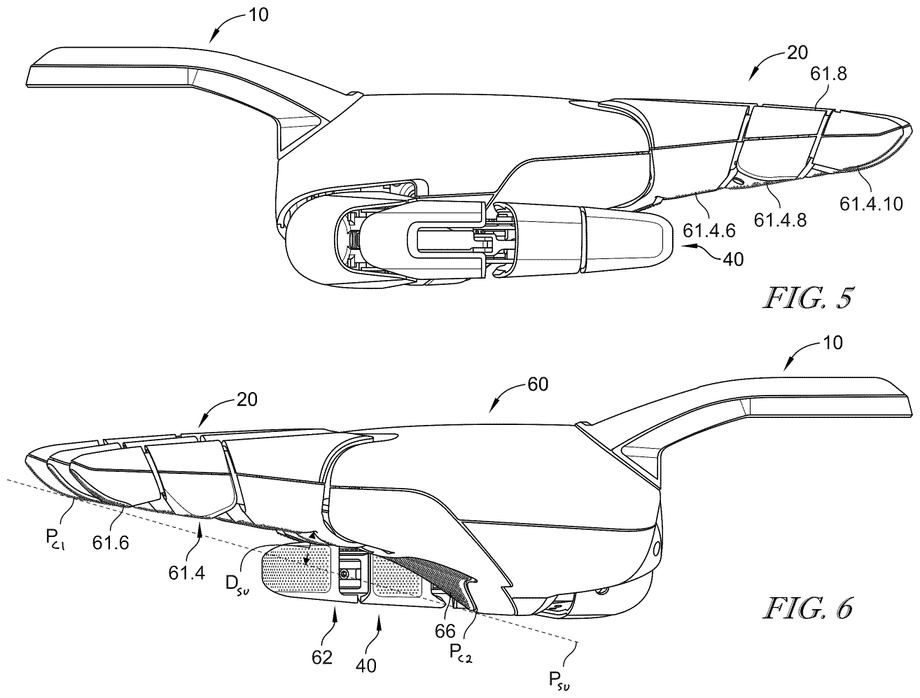

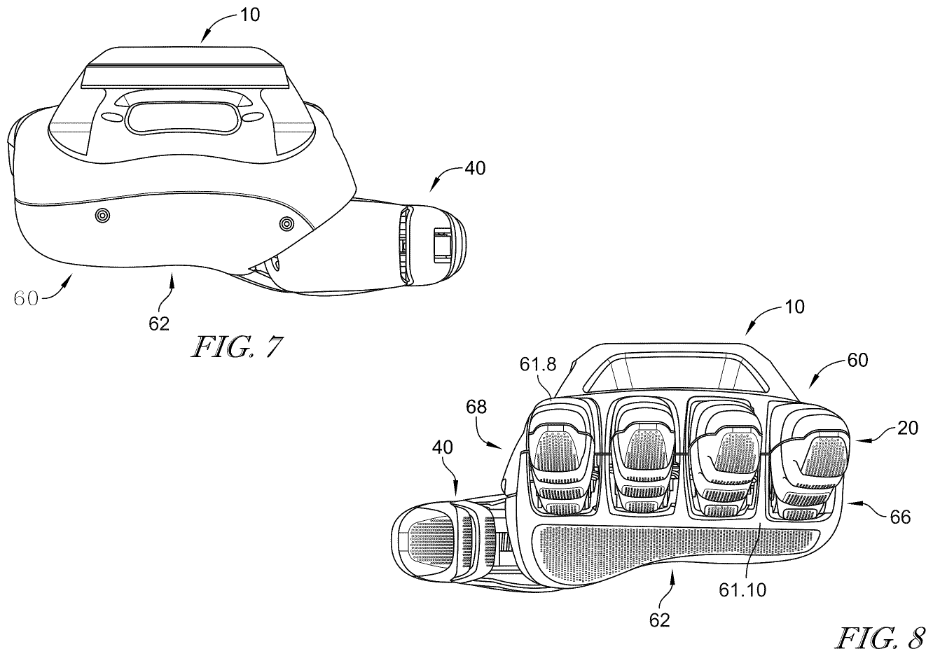

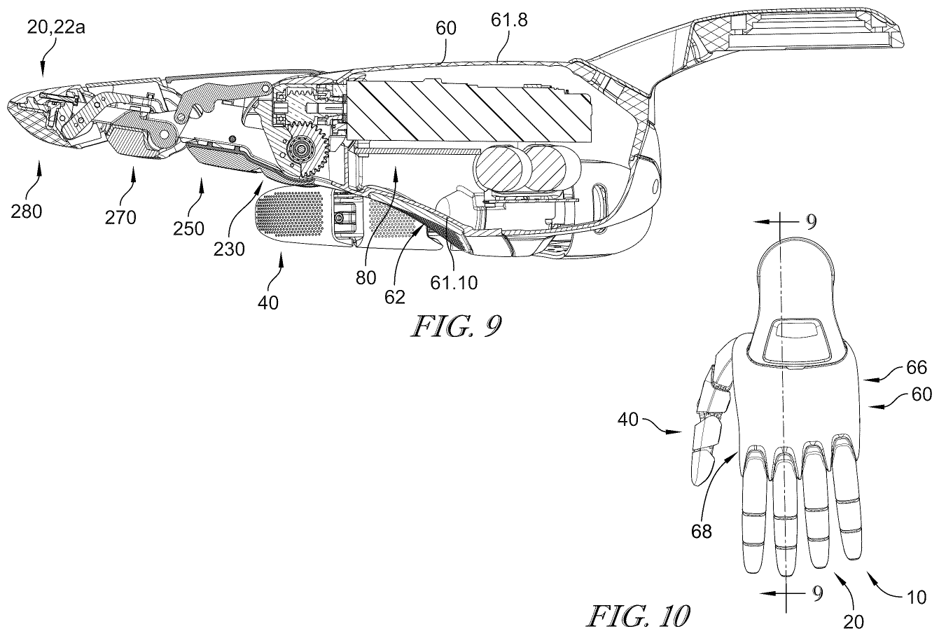

With reference, for example, to FIGS. 1-14, the end effector 10 includes: (i) a set of finger assemblies 20 with at least one finger assembly 22n (as shown, the set of finger assemblies 20 includes four finger assemblies 22a, 22b, 22c, 22d), (ii) a thumb assembly 40, (iii) a housing assembly 60, and (iv) electronics 80 that are configured to control each finger assembly 22n of the set of finger assemblies 20 and the thumb assembly 40. As shown in the figures, the housing assembly 60 is configured to: (i) encase and protect the electronics 80, and (ii) securely locate each of the finger assemblies 22a-22d and the thumb assembly 40 in a particular position relative to each other and the housing assembly 60. The housing assembly 60 may have: (i) a palm 62, (ii) a back 64, (iii) left and right sides 66, 68, and (iv) a front 70. It should be understood in alternative embodiments, the end effector 10 may include a single finger, two fingers, three fingers, or five fingers. In a further alternative, the end effector 10 may not include a single finger assembly, but instead may include a plurality of thumb assemblies.

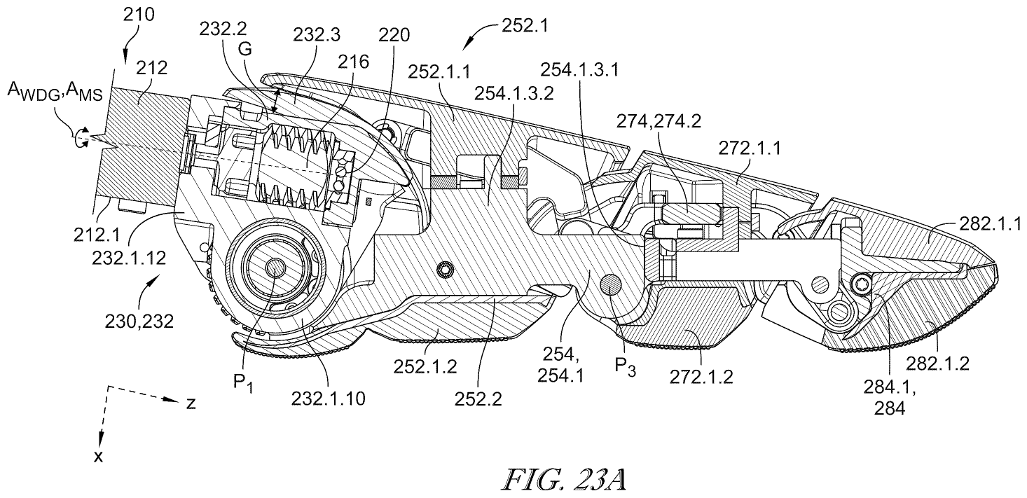

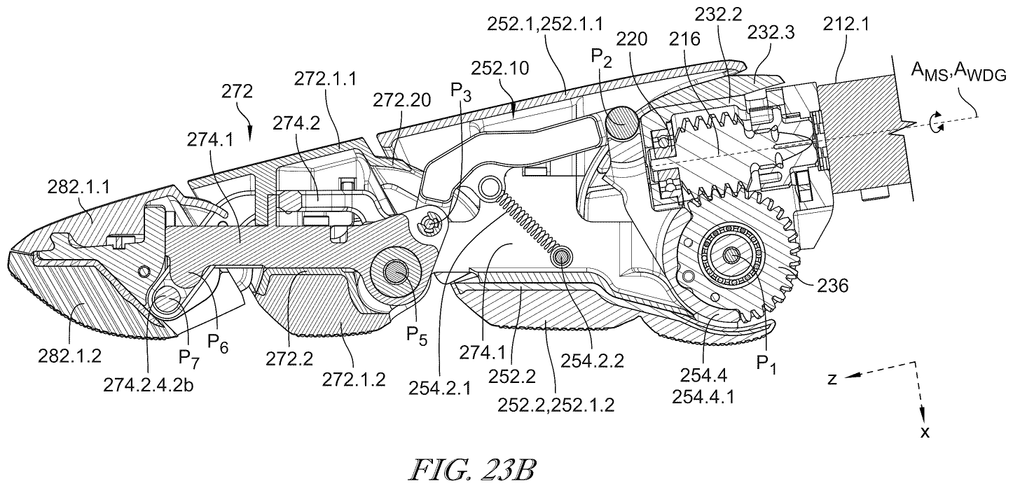

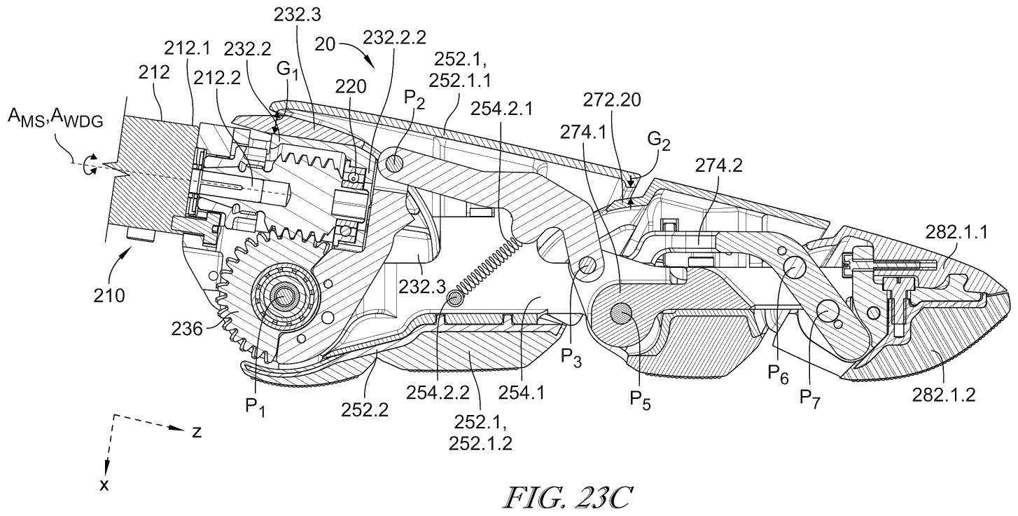

As shown in FIGS. 23A-25, said housing assembly 60 may include multiple components that are made from different materials, may include multiple layers that are made from different materials, and/or may be made from materials that have different rigidities, densities, C/D ratios, durabilities, fabrication methods, and the alike. For example, the frame 61.2 may be made from a first material with a first rigidity, the exterior top housing 61.8 may be made from a second material with a second rigidity, the interior bottom housing 61.10 may be made from a third material with a third rigidity, and wherein said first rigidity is greater than the second rigidity, and the second rigidity is greater than the third rigidity. For example, the frame 61.2 may be made from rigid metal, the exterior top housing 61.8 may be made from rigid plastic, and the interior bottom housing 61.10 may be made from deformable silicon or soft plastic. It should be understood that these are examples of possible materials and configurations and are not intended to be limiting in any manner. In other embodiments, the exterior or skin of the end effector 10 may be as rigid as the internal link assemblies of the housing assembly 60, wherein the housing and the internal link assemblies are both made from a durable and hard plastic. In further embodiments, the exterior or skin of the end effector 10 may be more rigid than the internal link assemblies of the housing assembly 60.

As described above in an alternative embodiment, the interior bottom housing 61.10 may include a plurality of layers 61.20, wherein a first interior layer 61.20.2 that is made from a first material having a first rigidity and a second exterior layer 61.20.4 that is made from a second material having a second rigidity. In this example, the first material may be rigid plastic or metal, while the second material is deformable silicon, soft plastic, or deformable textile or fabric. It should be understood that the second material may be replaceable (i.e., removably coupled) or may not be permanently affixed to the end effector 10. This design may allow for a softer material to be used on the palm surface of the end effector 10 that is designed to be less durable, and thus needs to be replaced when damaged or at pre-defined intervals (e.g., 1 week, 1 month, 6 months, 1 year, 5 years, or any interval between 1 day and 10 years). In other examples, the plurality of layers 61.20 may have three layers, wherein the first layer 61.20.2 is rigid to provide protection for the internal components, a second layer 61.20.4 is less rigid than the first layer 61.20.2 to enable the end effector 10 to pick up delicate items, and a third layer 61.20.6 that is designed to protect the second layer 61.20.4. In this example, the first layer 61.20.2 may be made from durable plastic or metal, the second layer 61.20.4 may be made from deformable thermoplastic, and the third layer 61.20.6 may be made from textile, cloth, or fabric (e.g., glove). Said third layer 61.20.6 may be replaceable at pre-determined intervals and may be coupled to the end effector using snaps, buttons, removable fasteners, push-pins, or any other type of mechanical coupling mechanism. In a final example, the plurality of layers 61.20 may have any number of layers, wherein layer 61.20.8 represents layer number four through the nth layer.

Examples of materials that may be used in the end effector 10 include, but are not limited to, metal (e.g., aluminum, stainless steel, titanium alloys, magnesium alloys, copper alloys, nickel-based alloys), carbon fiber composites, glass fiber composites, basalt fiber composites, Kevlar® composites, polycarbonate, acrylic (PMMA), acrylonitrile butadiene styrene (ABS), nylon, polyoxymethylene (POM), polyether ether ketone (PEEK), polyetherimide (PEI), polyphenylene sulfide (PPS), polytetrafluoroethylene (PTFE), polypropylene (PP), polyethylene (PE), high-density polyethylene (HDPE), thermoplastic polyurethane (TPU), polyamide-imide (PAI), other plastic (e.g., may include a polymer composition), rubber (e.g., nitrile rubber, EPDM), silicone, polyurethane elastomers, ceramic materials (e.g., alumina, zirconia), a combination of these materials, and/or any other suitable material. Additionally, the housing assembly 60 and other components of the end effector 10 may be injection molded, 3D printed, subtractive manufactured, or created using any other known method of manufacturing.

FIG. 6 shows a finger side view of the end effector 10, wherein a surface plane P_{SU} has been added to illustrate the contact points between the palm side of the housing assembly 60 and a flat or planar surface. For example, the surface plane P_{SU} may represent the outermost surface formed by a tote designed to carry parts or components of a car. As shown in this Figure, two main contact points are formed between said surface and the end effector 10, wherein a first contact point P_{C1} is formed near the tip of the middle finger 22b and a second contact point P_{C1} is formed near the base of the palm. The greatest distance D_{SU} between said surface plane P_{SU} and the housing 60 formed near the knuckle assembly is less than 10 mm, preferably less than 5 mm, and most preferably less than 1 mm. As shown in this Figure, it is beneficial to have the palm or inner surface of the end effector 10 flat or nearly flat to help maximize the contact surface area between the end effector 10 and the surface plane P_{SU}, as this design simplifies approach angles, and reduces the need to perform complex grasping movers with the wrist.

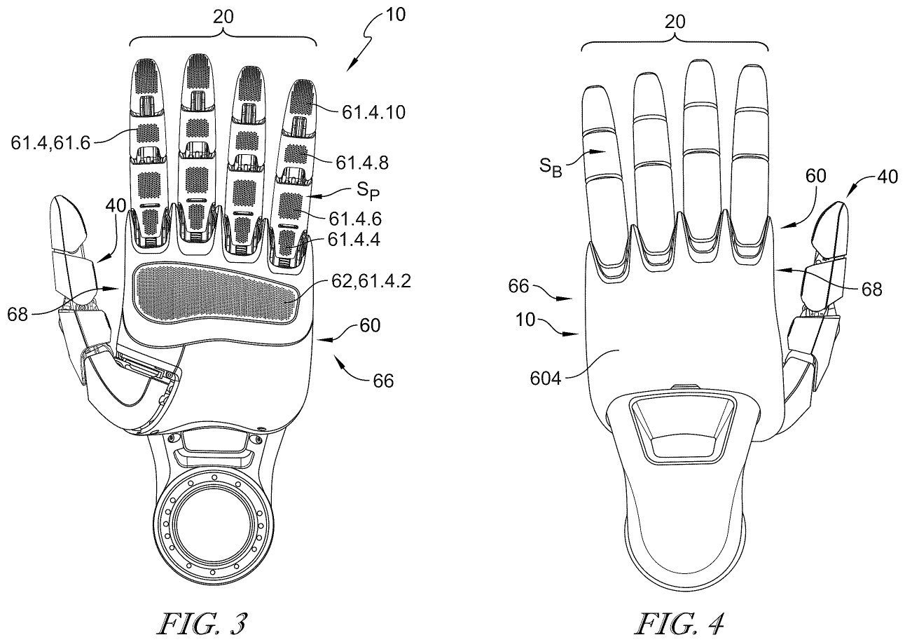

As best shown in FIGS. 3-4, the housing 60 includes a substantially smooth top or back surface SB and a rough or non-smooth bottom or palm surface Sp. The rough or non-smooth palm surface Sp is created by adding a plurality of contact areas 61.4. In other words, the entire palm surface Sp is not rough or non-smooth. Said plurality of contact areas 61.4 is designed to increase the end effector's 10 to grasp and hold an object. Specifically, the plurality of contact areas 61.4 are comprised of distinct regions 61.4.2-61.4.10 that include multiple bumps or projections 61.6. Said regions 61.4.2-61.4.10 are formed on the palm, and each assembly (i.e., proximal, medial, and distal) contained within each finger assembly 22a-22d. For example, the palm 62 may have one large contact region 61.4.2, the proximal assemblies of the fingers 22a-22d may include two contact regions 61.4.4, 61.4.6, the medial assemblies of the fingers 22a-22d may include one contact region 61.4.8, and the distal assemblies of the fingers 22a-22d may also include one contact region 61.4.10. The height of the bumps or projections 61.6 may be 0.01 mm to 2 mm, and preferably between 0.25 mm and 0.75 mm. It should be understood that in other embodiments, the plurality of contact areas 61.4 may be omitted, the number of regions contained in the plurality of contact areas 61.4 may be increased (e.g., between 18 and 100) or decreased (e.g., between 1 and 16), the number of bumps or projections 64 within each region may be increased or decreased, and/or the height of the bumps or projections 61.6 may be increased or decreased.

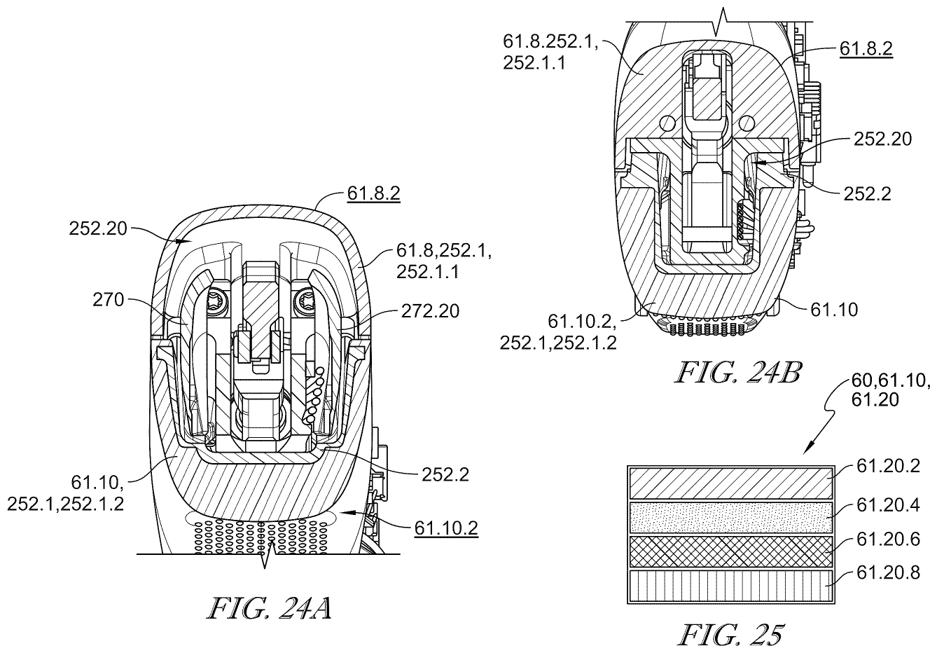

As best shown in FIGS. 24A-24B, the housing 60 of each finger assembly 22a-22d and specifically the outer surfaces 61.8.2, 61.10.2 of the exterior top housing 61.8 and the interior bottom housing 61.10 have a cross-sectional shape that is similar to an obround or a discorectangle. This cross-sectional shape is desirable because it provides a narrow width, rounded edges that help the finger assemblies avoid contact with one another, and substantially flat surfaces that help the finger assemblies maximize contact with the object it is grasping. In an exemplary embodiment, the width of the finger housing is between 40% to 80%, and preferably between 55% and 70% of the height of the finger housing. It should be understood that in other embodiments, the width-to-height ratio may be altered or changed in a manner that causes the height to be less than the width. However, this design or configuration may not be desirable because it limits the space within the housing for components while limiting the dexterously of the end effector 10.

With reference, for example, to FIGS. 1-13, the end effector 10 comprises a thumb assembly 40. The thumb assembly 40 is coupled to the palm surface 61.2.2 of the frame 61.2 and is replaceable (and in some embodiments, it may be hot-swapping with a replacement thumb assembly 40). The replaceable aspect of the thumb assembly 40 eliminates the need for various structural elements, such as synthetic tendons or articulation cables, pulleys, pneumatic or hydraulic cables, and other components that extend from the lower arm or wrist to the medial or distal sections of the thumb assembly 40. This configuration ensures that components such as linkages, motors, PCBs, encoders, and other elements required to actuate each thumb assembly 40 are self-contained within the palm and/or the thumb assembly 40 and are not spread throughout the robot system. This setup is advantageous as it enhances serviceability, consequently reducing the overall cost of ownership and usage. As shown in FIG. 13, the thumb motor plane P_{TM} is offset by an angle gamma γ from line L₁, wherein: (i) line L₁ is perpendicular to the sagittal plane P_{S} or the middle finger plane P_{22b} and intersects with the center point of the knuckle assembly of the middle finger 22b, and (ii) the an angle gamma γ is usually at least 1 degree, preferably between 2 degrees and 12 degrees, and most preferably between 4 degrees and 6 degrees, and likely less than 16 degrees.

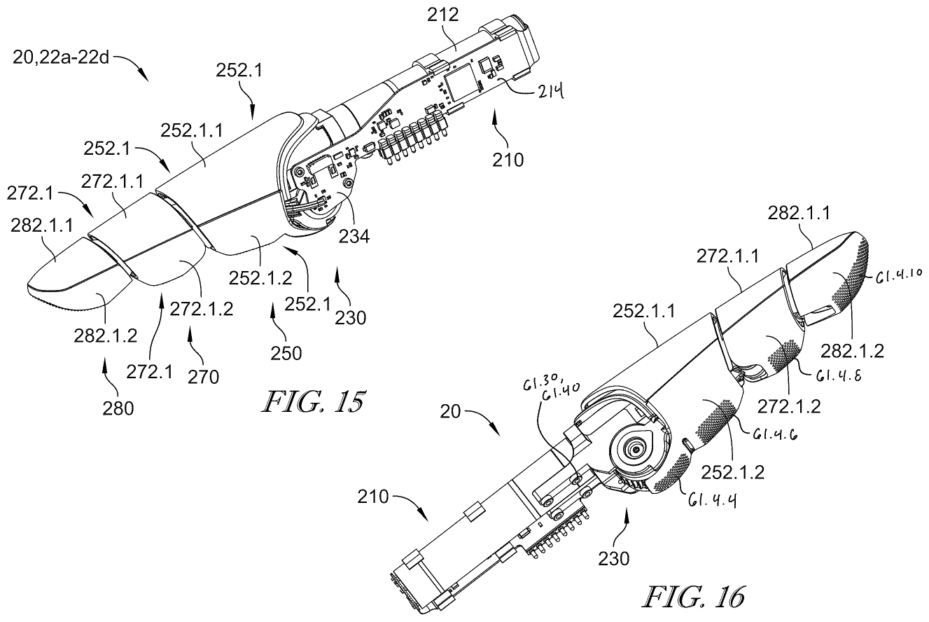

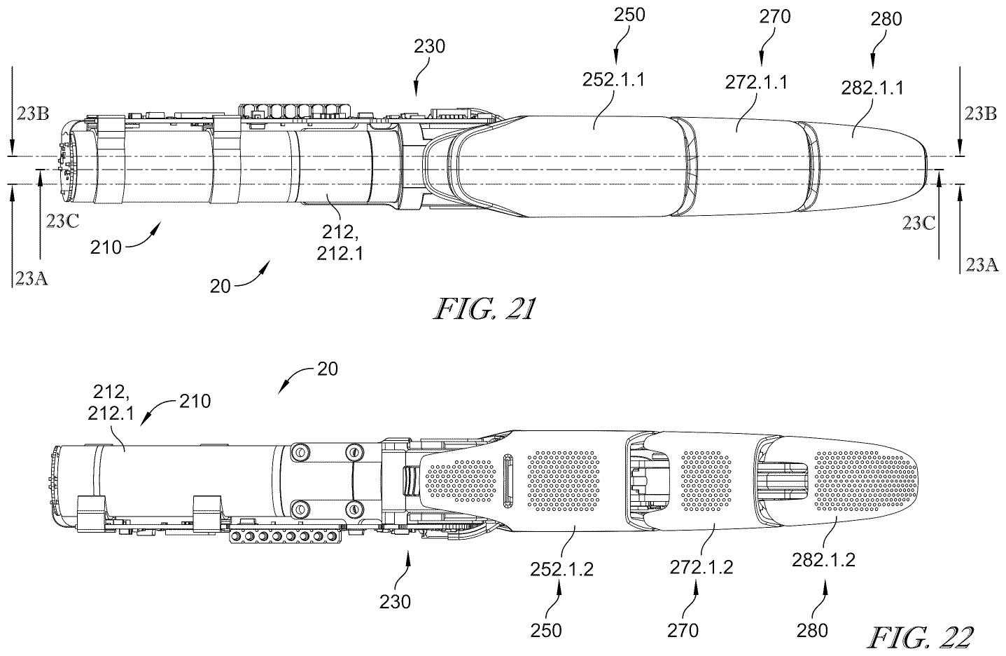

With reference, for example, to FIGS. 15-25, the end effector 10 comprises four identical finger assemblies 22a-22d that are coupled to the back surface 61.2.4 of the frame 61.2 and are configured to operate independent of one another. In embodiments, the end effector 10 may include more or fewer than four finger assemblies. Configuring the finger assemblies 22a-22d identically allows for reducing the number of distinct components required to manufacture the finger assemblies 22a-22d, and enhances modularity, thus reducing expense. The modular nature of the finger assemblies 22a-22d enables them to be easily replaceable and may enable hot-swapping of the finger assemblies. The modular and replaceable aspect of the finger assemblies 22a-22d eliminates the need for various structural elements, such as synthetic tendons or articulation cables, pulleys, pneumatic or hydraulic cables, and other components that extend from the lower arm or wrist to the medial or distal sections of the finger assemblies 20. This configuration ensures that components such as linkages, motors, PCBs, encoders, and other elements required to actuate each finger assembly 22a-22d are self-contained within the palm and/or within each finger assembly 22a-22d and are not spread throughout the robot system. This setup is advantageous as it enhances serviceability, consequently reducing the overall cost of ownership and usage.

In other embodiments, it should be understood that finger assemblies 22a-22d may not be identical. Instead, there may be two pairs of finger assemblies, wherein the finger assemblies contained in said pairs of finger assemblies are identical. In other words, there may be two unique types of finger assemblies contained in said end effector 10, wherein there are two finger assemblies of a first type and two finger assemblies of a second type. For example, the pointer finger 22a and the small finger 22d may be the first type, while the middle finger 22b and the ring finger 22c may be the second type (while the middle and ring 22b, 22c are different from the pointer and small 22a, 22d). In another example, the pointer finger 22a and the middle finger 22b may be the first type, while the ring finger 22c and the small finger 22d may be the second type (while the ring and small 22c, 22d are different from the pointer and middle 22a, 22b). In an additional embodiment, there may be two unique types of finger assemblies contained in said end effector 10, wherein there are three finger assemblies of a first type and one finger assembly of a second type. For example, the pointer, middle, and ring fingers 22a-22c may be of the first type and the small finger 22d may be of the second type. In another embodiment, there may be three unique types of finger assemblies contained in said end effector 10, wherein there are two finger assemblies of a first type, one finger assembly of a second type, and one finger assembly of a third type. For example, the middle and ring fingers 22b, 22c may be the first type, the pointer finger 22a may be of the second type to allow for abduction, and the small finger may be of the third type 22d due to its size. In a further embodiment, all finger assemblies 22a-22d may be unique. Finally, it should be understood that other combinations of finger assembly types are contemplated by this application, and the above examples are not intended to be limiting.

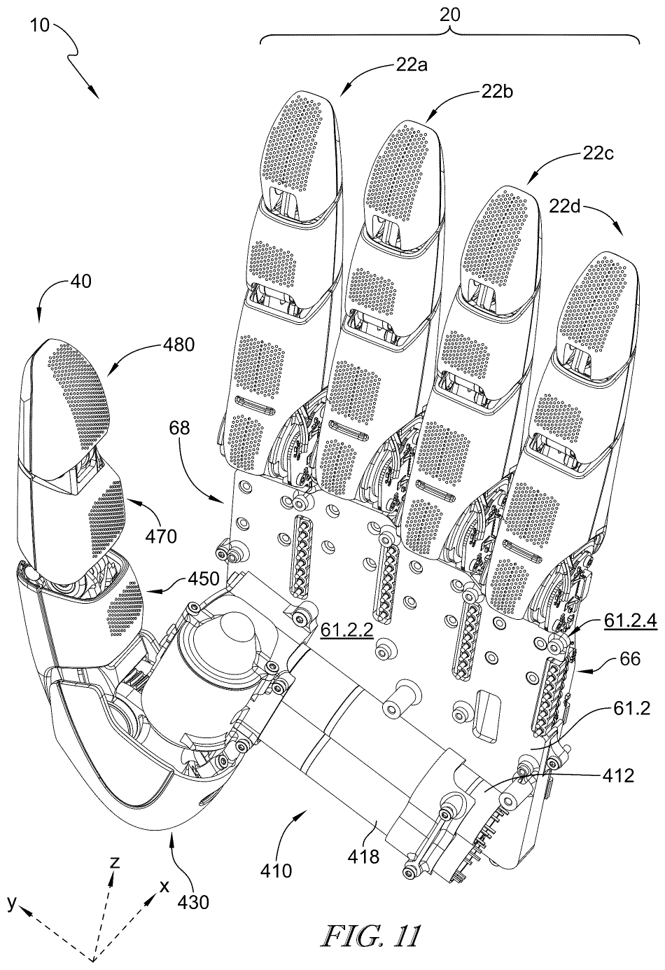

With reference, for example, to FIGS. 11-14, each finger assembly 22a-22d may be connected to the back surface 61.2.4 of the frame 61.2. Thus, the overall location of the figure assembly 22a-22d cannot move in the Y-Z plane. Also, the finger assemblies 22a-22d may be connected to the frame 61.2 in a manner that ensures that the tips are not aligned with one another. In other words, each finger assembly 22a-22d is: (i) angularly offset and horizontally offset to at least one other finger assembly 22a-22d in the X-Y plane, and (ii) vertically offset to at least one other finger assembly in the X-Z plane. This configuration of finger assembly 22a-22d enables each finger assembly 22a-22d of the four finger assemblies 22a-22d to be angularly offset along the X-Y plane and within the Y-Z plane with respect to every other finger assembly 22a-22d of the four finger assemblies 22a-22d. The fixed position of the finger assemblies 22a-22d may reduce the complexities of building, using, maintaining, and repairing the end effector 10.

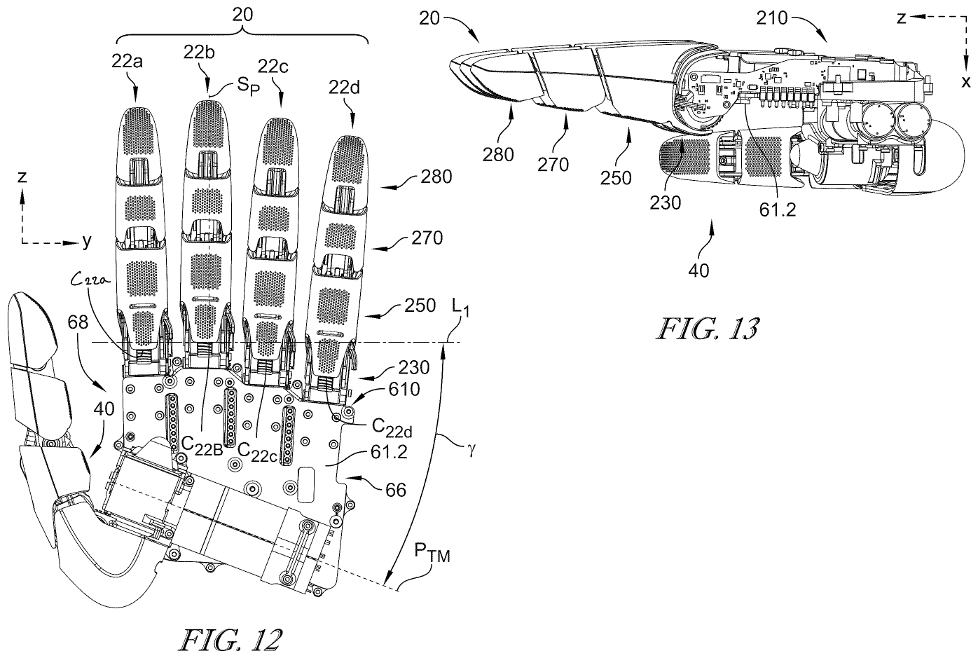

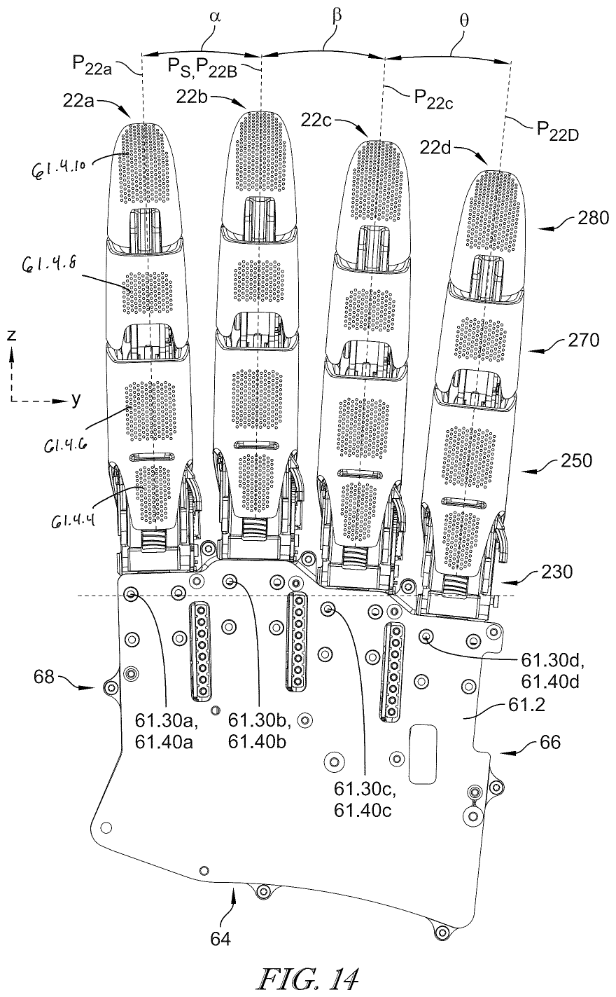

As shown, the middle or third finger assembly 22b is positioned such that its sagittal plane is orientated substantially vertically on the page. Based on the position of the middle or third finger assembly 22b, it can be seen that the center (i.e., C₂₂ₐ, C_{22c}, C_{22d}) of a knuckle assembly 230 of each of the pointer, ring, and small fingers 22a, 22c, and 22d are positioned: (i) slightly rearward from the line L₁ and the center C_{22b} of the knuckle assembly of the middle finger 22b (see FIG. 12), and (ii) are angled relative to the center of the knuckle assembly 230 of the middle finger 22b (see FIG. 14). This configuration also causes the fasteners 61.30a-61.30b that removably connected the finger assemblies 22a-22d at a respective point 61.40a-61.40d to the frame 61.2 to be not co-linear. At best, two of the respective point 61.40a-61.40d may be co-linear, but all four points are not co-linear. However, all four respective point 61.40a-61.40d are aligned in the same Y-Z plane.

FIGS. 11-14 also show that the pointer finger plane P₂₂ₐ that bisects the pointer finger 22a along its length is offset from the sagittal plane P_{S} or the middle finger plane P_{22b} by an angle alpha α, wherein the angle alpha α is usually at least 0.25 degree, preferably between 0.5 degrees and 5 degrees, and most preferably between 2 degrees and 3 degrees, and likely less than 7 degrees. Likewise, the ring finger plane P_{22c} that bisects the ring finger 22c along its length is offset from the sagittal plane P_{S} or the middle finger plane P_{22b} by an angle beta β, wherein the angle beta β is usually at least 0.25 degree, preferably between 0.5 degrees and 5 degrees, and most preferably between 2 degrees and 3 degrees, and likely less than 7 degrees. Finally, the small finger plane P_{22d} that bisects the small finger 22c along its length is offset from the ring finger plane P_{22c} by an angle theta θ, wherein the angle theta θ is usually at least 0.25 degree, preferably between 0.5 degrees and 5 degrees, and most preferably between 2 degrees and 3 degrees, and likely less than 7 degrees.

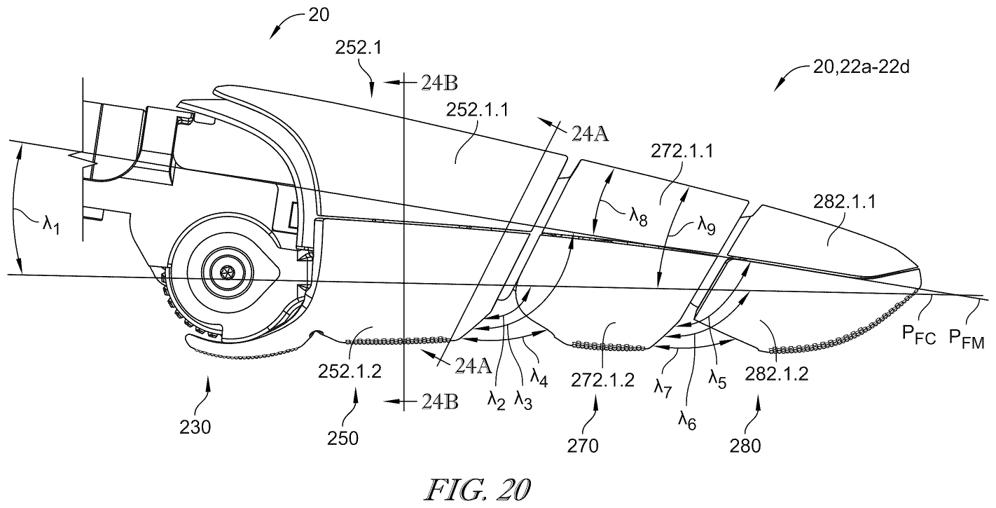

Exemplary positional relationship between components of a finger assembly 22a-22d is shown in FIG. 20 are listed in Table 1. It should be understood that the dimensions, angles, ratios, and other values that can be derived therefrom that are disclosed in the figures and Tables 1-3 are important to ensure that the end effector 10 can move, grasp objects, and be used in the desired robot system. As such, the structures, features, dimensions, angles, ratios, and other values that can be derived therefrom of non-end effectors for robots and non-linkage based end effectors cannot be simply adopted or implemented into an end effector without careful analysis and verification of the complex realities of designing, testing, manufacturing, training, and using the robot system with an end effector. Theoretical designs that attempt to implement such modifications from non-end effectors for robots and non-linkage based end effectors are insufficient (and in some instances, woefully insufficient) because they amount to mere design exercises that are not tethered to the complex realities of successfully designing, testing, manufacturing, training, and using the robot system with an end effector.

TABLE 1

| | Lower | Upper | Preferred Lower | Preferred Upper |
|---|---|---|---|---|
| Angle | Bound | Bound | Bound | Bound |
| λ1 | 6.4° | 10.6° | 7.6° | 9.3° |
| λ2 | 104.5° | 174.2° | 125.4° | 153.3° |
| λ3 | 98.2° | 163.6° | 117.8° | 144° |
| λ4 | 81.1° | 135.2° | 97.4° | 119° |
| λ5 | 103.1° | 171.8° | 123.7° | 151.1° |
| λ6 | 96.7° | 161.2° | 116° | 141.8° |
| λ7 | 84.6° | 140.9° | 101.5° | 124° |
| λ8 | 4.1° | 6.9° | 5° | 6.1° |
| λ9 | 10.5° | 17.5° | 12.6° | 15.4° |

TABLE 2

| | |
|---|---|
| P₂₂ₐ | Pointer Finger Plane |
| P_{S}, P_{22b} | Sagittal Plane or Middle Finger Plane |
| P_{22c} | Ring Finger Plane |
| P_{22d} | Small Finger Plane |
| P_{FM} | Finger Motor Plane |
| P_{TM} | Thumb Motor Plane |
| P_{FC} | Finger Coronal Plane |
| P_{SU} | Surface Plane |

TABLE 3

| | |
|---|---|
| P₁ | First Pivot Point - Fixed |
| P₂ | Second Pivot Point - Not Fixed |
| P₃ | Third Pivot Point - Not Fixed |
| P₄ | Fourth Pivot Point - Semi-Fixed |
| P₅ | Fifth Pivot Point - Semi-Fixed |
| P₆ | Sixth Pivot Point - Semi-Fixed |
| P₇ | Seventh Pivot Point - Not Fixed |

### C. Finger Assembly

With reference, for example, to FIGS. 15-25, each finger assembly 22a-22d of the end effector 10 is comprised of a motor assembly 210, a knuckle assembly 230, a proximal assembly 250, a medial assembly 270, and a distal assembly 280. Each of the knuckle assembly 230, proximal assembly 250, medial assembly 270, and distal assembly 280 include internal linkages (in combination, internal linkage assembly) that can operate together to move the finger assembly 22a-22d. Each of these assemblies will be discussed in great detail below; however, additional information about said assemblies may be contained within U.S. Provisional Patent Applications Nos. 63/614,499, 63/617,762, 63/561,315, 63/573,226, 63/615,766, 63/620,633, all of which are incorporated herein by reference for any purpose.

a. Motor Assembly

The motor assembly 210 is configured to be releasably coupled to the top surface 61.2.4 of the housing frame 61.2, and includes: (i) a motor 212, (ii) controller 214, (iii) a worm drive gear 216 that is coupled to an extent of the motor 212, and (v) a worm drive gear bearing 220. Motor 212 may be a slotless BLDC motor, a brushed DC motor, a stepper motor, a switched reluctance motor, a permanent magnet synchronous motor, a servo motor, or any other suitable motor. As shown in the Figures, the motor assembly 210 for each finger assembly 22a-22d only includes a single motor 212; thus, said finger assembly 22a-22d does not include more than one motor 212. By limiting the number of motors 212 to the number of finger assemblies 22a-22d, the end effector 10 becomes underactuated. Stated a different way, each finger assembly 22a-22d includes three joints or 3 degrees of freedom (DoF), wherein each of the three joints or DoFs are controlled by a single motor 212. This not only simplifies manufacturing, increases durability, enables the figure assemblies 22a-22d to be modular, but also reduces cost and complexity of control.

As best shown in FIG. 23C, the motor 212 includes: (i) internal components (not shown), (ii) a motor housing 212.1, and (iii) a motor shaft 212.2. The internal components of the motor 212 are designed to rotate the motor shaft 212.2 about a motor shaft axis A_{MS}. To help ensure that the motor shaft 212.2 rotates about the motor shaft axis A_{MS} at the desired speed, the internal components of the motor 212 may include a transmission, gear reduction, or other component. In addition to altering the speed of the motor shaft 212.2, it should be understood that the transmission, gear reduction, or other component may prevent the motor shaft 212.2 from making full revolutions (i.e., 365 degrees) around the motor shaft axis A_{MS}. In fact, it may be beneficial to physically limit the rotational movement of the motor shaft 212.2 (as opposed to electronically limiting said rotation using programming or control methodologies) because it helps ensure that the finger assembly 22a-22d cannot be over-rotated. However, in other embodiments, the transmission, gear reduction, or other component may not prevent the motor shaft 212.2 from making full revolutions (i.e., 365 degrees) around the motor shaft axis A_{MS}. In this embodiment, electronically limiting said rotation using programming or control methodologies may be used to help ensure that the finger assembly 22a-22d is not over-rotated. Alternatively, it may be desirable to allow the motor shaft 212.2 to full revolutions (i.e., 365 degrees) based on the gearing ratio.

As shown in the Figure, the worm drive gear 216 extends past a frontal portion of the motor housing 212.1 and: (i) includes an extent that is designed to receive the motor shaft 212.2 to enable said worm drive gear 216 to be coupled to the motor shaft 212.2, and (ii) has helical or screw-like threads. Coupling said worm drive gear 216 to the motor shaft 212.2 enables the internal components of the motor 212 to rotate the motor shaft 212.2 around the motor shaft axis A_{MS}, wherein said rotation of the motor shaft 212.2 around the motor shaft axis A_{MS} causes the worm drive gear 216 to rotate about a worm drive gear axis A_{WDG}. Due to the configuration of the motor assembly 210 and the worm drive gear 216, the motor shaft axis A_{MS} and the worm drive gear axis A_{WDG} are parallel, aligned, and coaxial. Additionally, this configuration also causes the motor shaft axis A_{MS} and the worm drive gear axis A_{WDG} to be parallel with (and potentially, coaxial with) the finger motor plane PFM. It should be understood that in other embodiments, the motor shaft axis A_{MS}, the worm drive gear axis A_{WDG}, and finger motor plane PFM may not be parallel, aligned, and coaxial. Instead, the motor shaft axis A_{MS} and the worm drive gear axis A_{WDG} may be perpendicular to one another, while the finger motor plane PFM may be parallel with the motor shaft axis A_{MS}.

As described above, the motor assembly 210 also includes a worm drive gear bearing 220 that is positioned within an extent of the knuckle assembly 230 and is designed to support the distal, rotating end of the worm drive gear 216. In alternative embodiments, the worm drive gear bearing 220 may be omitted or integrally formed with the worm drive gear 216. It should also be understood that in alternative embodiments, the motor shaft and the worm drive gear may be integrally formed and/or sealed.

As best shown in FIGS. 23A-23C and discussed below, the worm drive gear 216 is designed to be in geared engagement with an extent of the knuckle assembly 230, wherein said geared engagement enables the rotation of the worm drive gear 216, via the motor shaft 212.2, to cause the finger assembly 22a-22d to move. As shown in the Figures, the motor assembly 210 is a part of the finger assembly 22a-22d and is not located in a remote portion of the robot system. While this limits the dimensions of the hand (i.e., how small), it reduces linkages, increases modularity, reduces parts, increases accessibility into the working environment and increases the reliability of the finger assembly 22a-22d.

b. Knuckle Assembly

The knuckle assembly 230 is positioned forward of a majority of the motor assembly 210 and is configured to allow the finger assembly 22a-22d to move from the open, uncurled, or neutral position to the closed, curled, or inwardly rotated position. In said closed, curled, or inwardly rotated position, an acute interior angle is formed between the palm 62 and an interior surface of the finger assembly 22a-22d. With reference, for example, to FIGS. 15 and 23A-23C, the knuckle assembly 230 includes: (i) a housing assembly 232, (ii) a knuckle PCB 234, and (iii) a worm wheel 236 that is in contact with and configured to interact with the worm drive gear 216.

The housing assembly 232 includes a frame 232.1, a knuckle cover 232.2, and an external skin 232.3. The frame 232.1 includes: (i) sidewalls 232.1.10, (ii) a headwall 232.1.12, and (iii) a rearward extending mounting projection 232.1.14. The mounting projection 232.1.14 is designed to be coupled with the motor housing 212.1, while the headwall 232.1.12 is designed to be positioned adjacent to a frontal extent of the motor housing 212.1. Thus, the frame 232.1 is positioned adjacent to both the lateral surface and the frontal surface of the motor housing 212.1. This helps provide sufficient support for the knuckle and the portion of the finger assembly 22a-22d that extends therefrom. In other words, the frame 232.1 is made from a material that is sufficiently rigid to withstand the torque/other forces that are associated with the movement of the various assemblies.

The sidewalls 232.1.10 of the frame 232.1 extend forward from the headwall 232.1.12. Said sidewalls 232.1.10 also form a proximal link aperture 232.1.2 that is configured to receive an extent of a worm wheel interface 256 (discussed further below) and is configured to: (i) be secured to an extent of the housing frame 61.2, and (ii) at least partially surround the worm wheel 236, worm drive gear 216, and an extent of the motor 212. This design helps protect the motor shaft 212.2 and the worm drive gear 216 from damage that may be caused by an external force. The sidewalls 232.1.10 also include: (i) coupling points 232.1.4 for the knuckle PCB 234, which is configured to control an extent of the finger assembly 22a-22d and provide positional information back to the robot system, and (ii) bearing apertures 232.1.20 that are designed to receive the bearings that allow the motor assembly 210 to continue driving the worm drive gear 216 after an extent of the proximal assembly 250 has reached a resistance point (e.g., contact with an object).

The knuckle cover 232.2 is positioned adjacent to the sidewalls 232.1.10, includes a frontal wall 232.2.2 that has a recess that is designed to receive the worm drive gear bearing 220, and is designed to overlay an upper extent of the worm drive gear 216. As such, the knuckle cover 232.2 supports and protects the worm drive gear 216 and an extent of the motor 212. The support and protection provided by the knuckle cover 232.2 allows the external skin 232.3 to be: (i) less rigid than the knuckle cover 232.2, (ii) easily replaceable in case of damage, and (iii) focused on minimizing the gap G that is formed between knuckle assembly 232 and the proximal assembly 250. To minimize the gap G, the external skin 232.3 has: (i) a left to right, arched configuration, (ii) a front to back, curvilinear design, and (iii) varying thicknesses (see FIGS. 23A-23C, 26). The complex design of the external skin 232.3 enables: (i) a substantial extent of the external skin 232.3 to be positioned within an extent of the proximal assembly 250, when the finger assembly 22a-22d is in the open, uncurled, or neutral position, and (ii) a minor extent of, or none of, the external skin 232.3 to be positioned within an extent of the proximal assembly 250, when the finger assembly 22a-22d is in the closed, curled, or inwardly rotated position. By enabling at least a minimal extent of the external skin 232.3 to be positioned within, or adjacent to, the proximal assembly 250, the gap G₁ formed between the assemblies 232 and 250 is minimized, and wherein said minimization of said gap G₁ is beneficial because it minimizes the chance or probability that a glove or external covering can be caught or pinched between these assemblies. In light of the above disclosure, the knuckle cover 232.2 may be made from metal or a sufficiently rigid material, while the external skin 232.3 may be made from deformable silicon, thermoset plastic, or any other suitable materials disclosed herein or known in the art.

The worm wheel 236 is a semi-circular toothed gear that is designed to be in geared engagement with the worm drive gear 216. In particular, the worm wheel 236 includes: (i) a toothed section 236.2 that includes 18 teeth that encircle 220 degrees of the worm wheel 236, (ii) a recessed portion 236.4 that is designed to receive an extent of the worm drive link 254.4.1, and (iii) a central bearing opening 236.6 that are designed to receive a first and second worm bearings 256.2a, 256.2b (as discussed below). Said worm wheel 236 is designed to rotate about a worm wheel axis Aww, wherein said worm wheel axis Aww is located at the center of the central bearing opening 236.6 and the first pivot point P₁. It should be understood that in other embodiments, the worm wheel 236 may include additional teeth (e.g., between 19 and 50) or fewer teeth (e.g., between 5 and 17). Additionally, the toothed section 236.2 may span more than 220 degrees (e.g., between 221 and 300 degrees) or span less than 220 degrees (e.g., between 100 and 119 degrees).

As discussed above, the rotation of the motor shaft 212.2 around the motor shaft axis A_{MS} causes the worm drive gear 216 to rotate about a worm drive gear axis A_{WDG}. The rotation of the worm drive gear 216 about a worm drive gear axis A_{WDG} causes the worm wheel 236 to rotate above the worm wheel axis Aww or the first pivot point P₁. Because the toothed section 236.2 of the worm wheel 236 only encircles 220 degrees of the worm wheel 236, said worm wheel 236 can only rotate approximately 220 degrees above the worm wheel axis Aww or the first pivot point P₁. In other words, the worm wheel 236 cannot fully rotate (i.e., at least 365 degrees or more) around the worm wheel axis Aww or the first pivot point P₁. Due to the configuration of the motor assembly 210, the worm drive gear 216, and worm wheel 236, the worm wheel axis Aww is perpendicular to the motor shaft axis A_{MS}, the worm drive gear axis A_{WDG}, and the finger motor plane P_{FM}. However, as shown in the Figures, both the motor shaft axis A_{MS} and the worm drive gear axis A_{WDG} are positioned above or away from the palm in comparison to the worm wheel axis Aww or the first pivot point P₁. In other words, the worm wheel axis Aww or the first pivot point P₁ underlies an extent of the motor shaft axis A_{MS} and the worm drive gear axis A_{WDG}.

The knuckle PCB 234 includes a first finger encoder (e.g., magnetic, optical, capacitive, resistive, etc.) that is positioned proximate to the metacarpophalangeal joint MJ and configured to collect proximal data, wherein said proximal data includes information related to the rotation of the metacarpophalangeal joint MJ. Said proximal data may use the robot system to generate a vector representation (e.g., a space embedding) indicating the state of the proximal assembly 250 or the environment around the proximal assembly 250. The encoder of the knuckle PCB 234 may collect data upon a specific command from the robot system or periodically (e.g., between 500 times per second to every minute). Also, as shown in the Figures, the controller 214 and said knuckle PCB can be co-located on a single PCB. In other embodiments, the controller 214 and the knuckle PCB 234 may be split on different PCBs.

c. Proximal Assembly

The proximal assembly 250 is positioned between the knuckle assembly 230 and the medial assembly 270 and is the first portion of the finger assembly 22a-22d configured to move relative to the housing frame 61.2 and the palm 62 in response to actuation of the motor 210 and worm drive gear 216. The proximal assembly 250 includes: (i) a proximal housing assembly 252, (ii) a proximal link assembly 254, (iii) the worm wheel interface 256, and (iv) a proximal PCB 258.

i. Proximal Housing Assembly

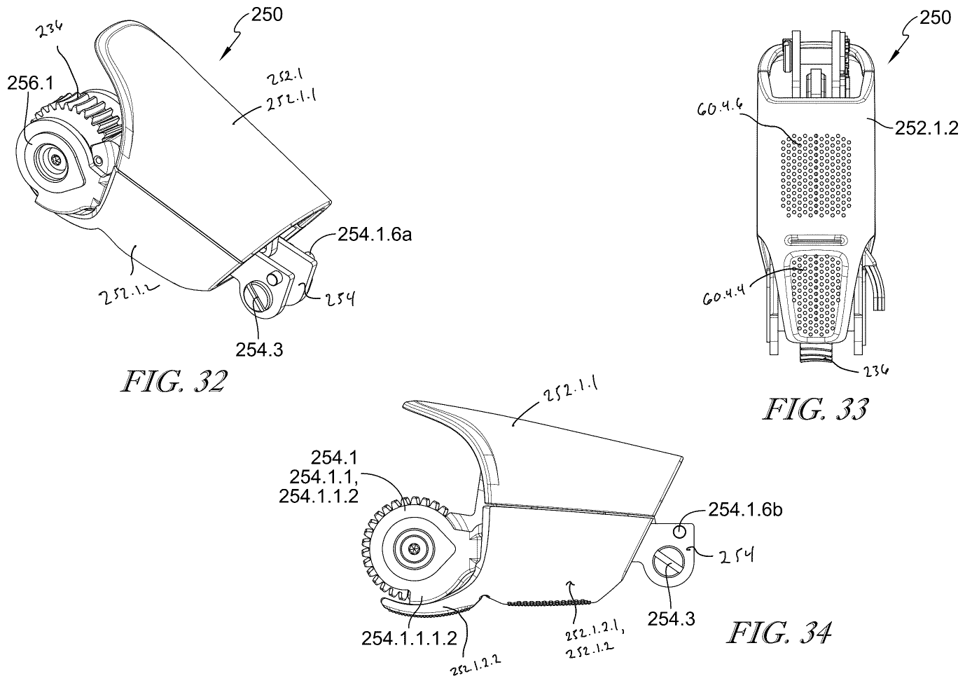

As shown in FIGS. 23A-24B and 32-34, the proximal housing assembly 252 is designed to substantially surround a majority of the other components of the proximal assembly 250. To achieve this, the proximal housing assembly 252 forms an internal proximal recess 252.18. The internal proximal recess 252.18 is designed to not only surround components of the proximal assembly 250, but is also designed to receive: (i) an extent of the medial assembly 270 (namely, the medial tongue 272.20), when the finger assembly 22a-22d is in the open, uncurled, or neutral position, and (ii) a lesser extent of, or none of, the medial assembly 270 (namely, the medial tongue 272.20), when the finger assembly 22a-22d is in the closed, curled, or inwardly rotated position. In other words, the proximal housing assembly 252 overlies: (i) a substantial extent of the medial tongue 272.20 when the finger assembly 22a-22d is in the open, uncurled, or neutral position, and (ii) a minor extent of, or none of, the medial tongue 272.20 when the finger assembly 22a-22d is in the closed, curled, or inwardly rotated position. Stated another way, the percentage of the medial assembly 270 (namely, the medial tongue 272.20) that is positioned within the proximal housing assembly 252 is reduced when the finger assembly 22a-22d moves from the open, uncurled, or neutral position to the closed, curled, or inwardly rotated position. By enabling at least a minimal extent of the medial assembly 270 (namely, the medial tongue 272.20) to be positioned within or adjacent to the proximal assembly 250, the gap G₂ formed between the assemblies 250 and 270 is minimized, and wherein said minimization of said gap G₂ is beneficial because it minimizes the chance or probability that a glove or external covering can be caught or pinched between these assemblies.

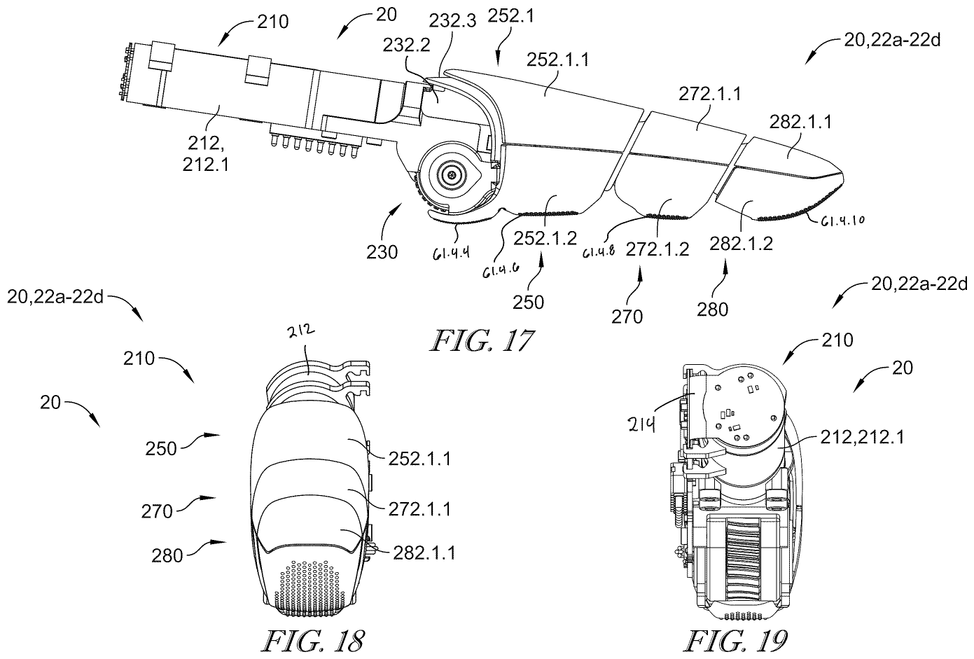

As shown in FIGS. 17-26 and 32-33, the proximal housing assembly 252 specifically includes: (i) a proximal jacket assembly 252.1 with a top member 252.1.1 and a bottom member 252.1.2, and (ii) a proximal bottom casing assembly 252.2. While the bottom member 252.1.2 is in direct contact with and underlies the proximal bottom casing assembly 252.2, the finger assembly 22a-22d lacks a proximal top casing assembly that is in direct contact with the top member 252.1.1. This design is advantageous because the proximal bottom casing assembly 252.2 provides the bottom member 252.1.2 with additional rigidity, which enables said bottom member 252.1.2 to be made from a softer, easier-to-form, and potentially less durable material, thereby increasing the gripping capability of the end effector 10. In contrast, the top member 252.1.1 does not need to include a softer, easier-to-form, and potentially less durable material because said top member 252.1.1 is not designed to come into regular contact with objects. Additionally, even if the materials of the proximal bottom casing assembly 252.2 and the bottom member 252.1.2 are the same, it may be desirable to form these components as two separate components to facilitate replicability without exposing an inner extent of the finger assembly 22a-22d. Another way of describing this beneficial configuration includes the fact that the proximal jacket assembly 252.1 is configured to provide the primary external shape of the finger assembly 22a-22d, while the proximal casing assembly 252.2 is configured to protect the proximal PCB 258 and provide a spacer between the proximal link assembly 254 and the proximal jacket assembly 252.1. Nevertheless, it should be understood that in an alternative embodiment, the bottom member 252.1.2 and the proximal bottom casing assembly 252.2 may be integrally formed as a single structure.

As best shown in FIGS. 23A-24B, the top member 252.1.1 of the proximal jacket assembly 252.1 includes an exterior surface back with a curvilinear extent in a first direction (namely, across the width of the finger assembly 22a-22d), and the bottom member 252.1.2 of the proximal jacket assembly 252.1 includes an exterior palm surface with a curvilinear extent in the first direction (namely, across the width of the finger assembly 22a-22d) and a second direction (namely, across the length of the finger assembly 22a-22d). The curvilinear extent in the first direction helps ensure that the finger assembly 22a-22d has rounded edges to help with grasping objects, while the curvilinear extent in the second direction helps ensure that the finger can curl inward. Additionally, the bottom member 252.1.2 of the proximal jacket assembly 252.1 may include a main body portion 252.1.2.1 and a rearward projection 252.1.2.2, wherein said main body portion is designed to be positioned forward of the first joint or metacarpophalangeal joint MJ, while the rearward projection 252.1.2.2 is designed to underlie and protect the metacarpophalangeal joint MJ. Due to the fact that the bottom member 252.1.2 includes two distinct portions 252.1.2.1, 252.1.2.2, said bottom member 252.1.2 also includes two contact regions 61.4.4, 61.4.6. It should be understood that in an alternative embodiment, the portions 252.1.2.1, 252.1.2.2 of the bottom member 252.1.2 may be omitted.

As discussed above, the proximal housing assembly 252 may be: (i) made from the same materials as the housing assembly 60, (ii) made from material that differs from the materials used in the housing assembly 60, and/or (iii) may include silicon, plastic (e.g., may include a polymer composition), carbon composite, or metal, a combination of these materials, any other material disclosed herein, and/or any other suitable material. Alternatively, the proximal housing assembly 252 may include additional components or layers (e.g., between three and an nth).

ii. Proximal Link Assembly

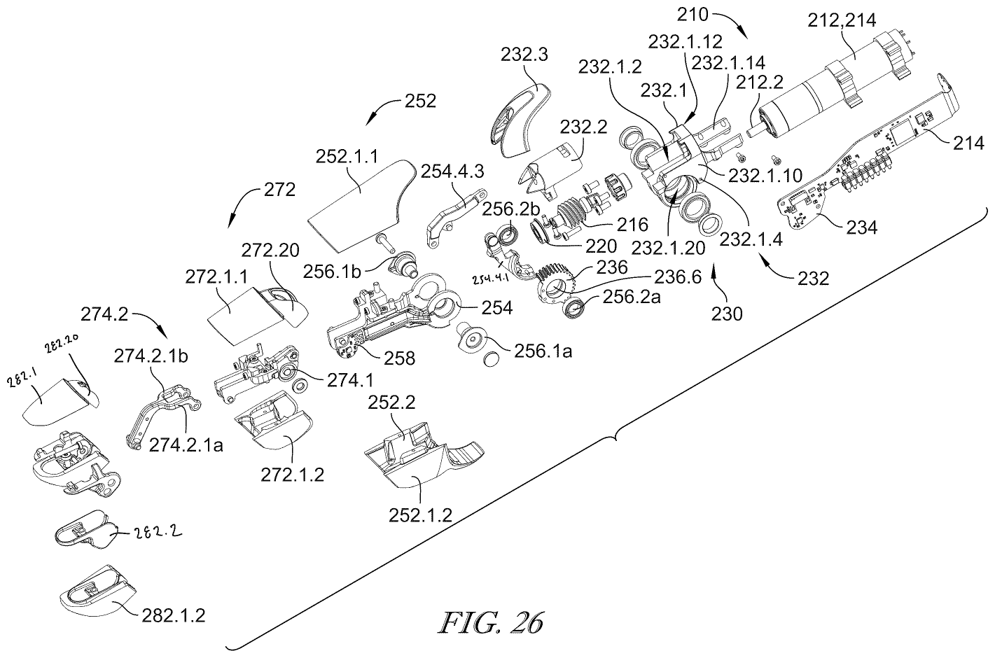

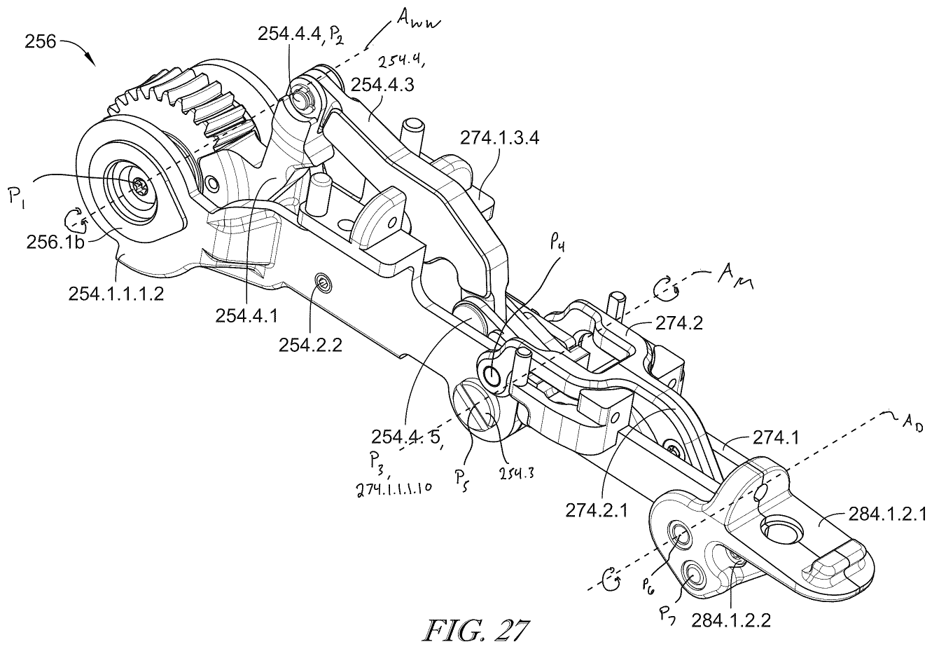

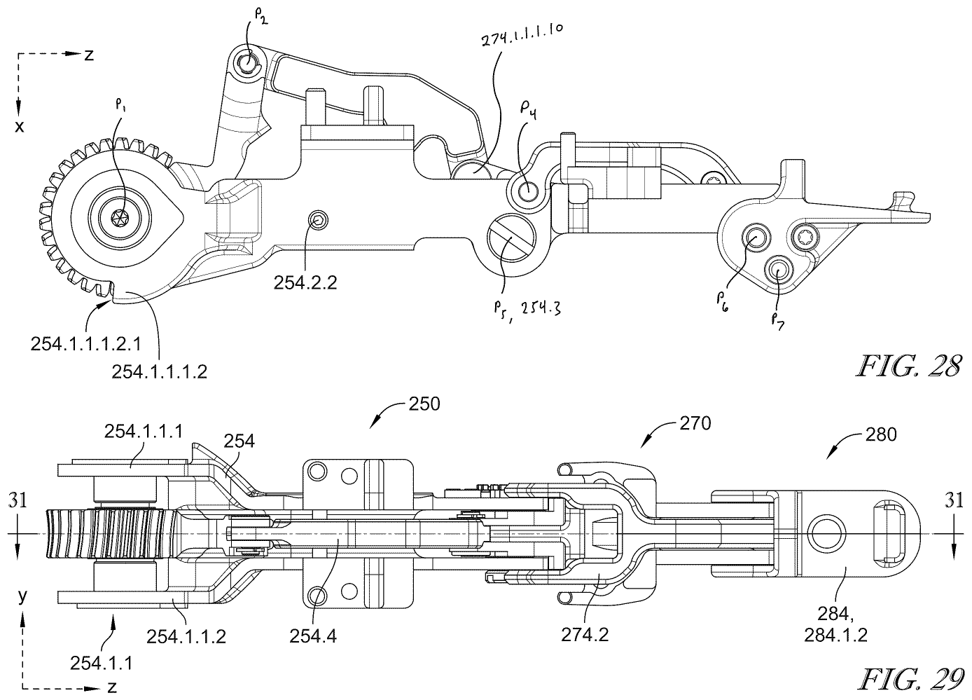

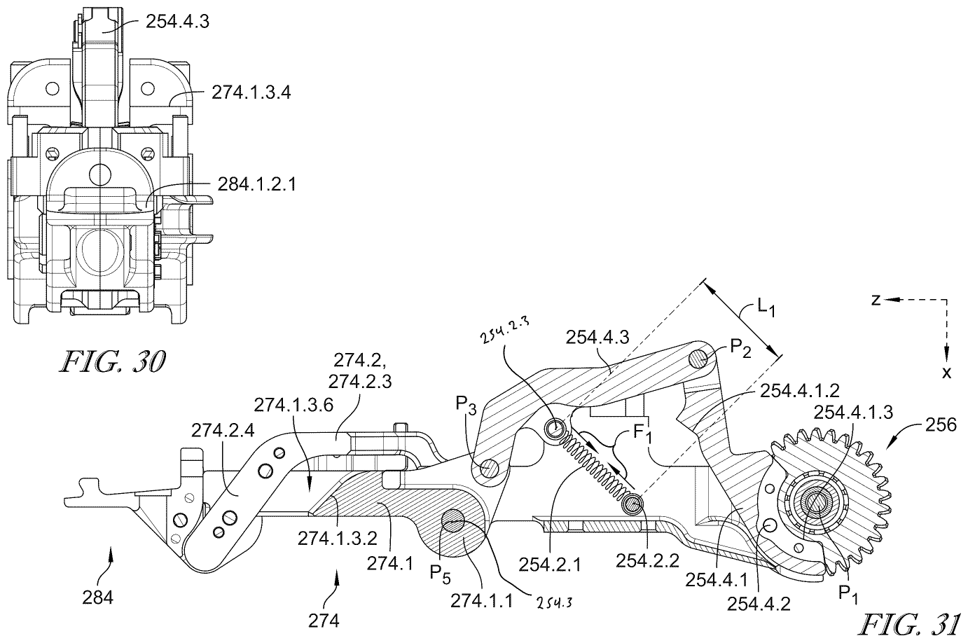

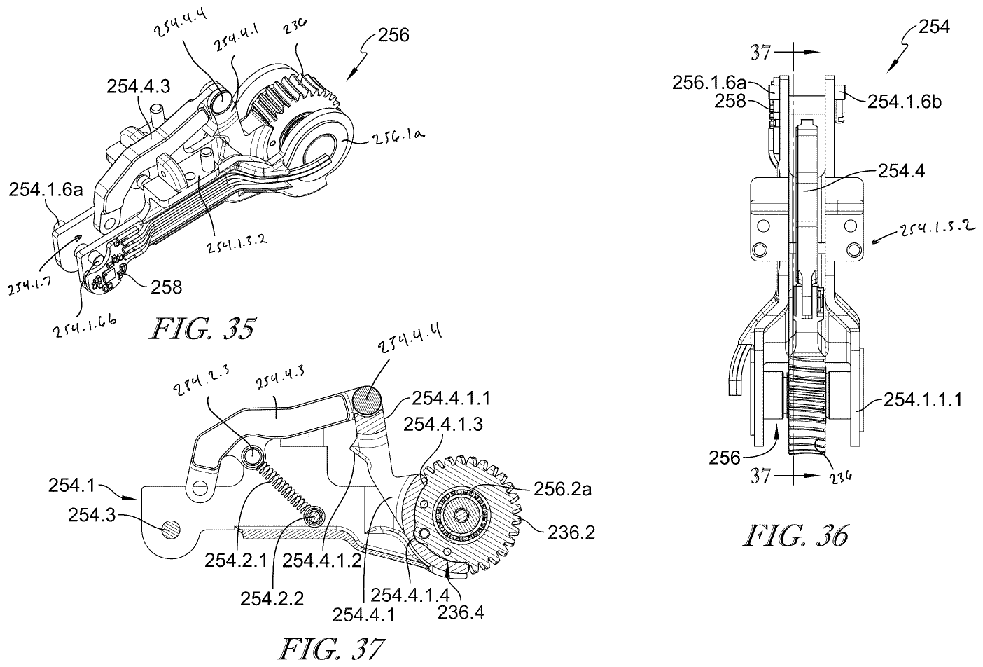

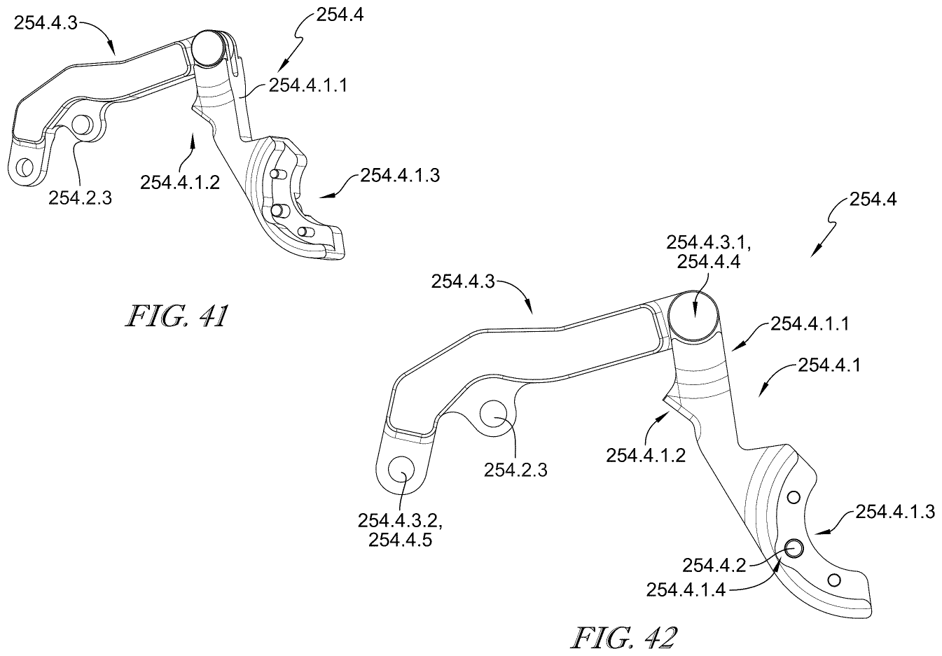

As shown in FIGS. 27-42, the proximal link assembly 254 includes: (i) a primary or main proximal link or first bar 254.1, (ii) a biasing assembly 254.2, (iii) a medial assembly coupler 254.3, and (iv) a proximal drive link assembly 254.4. The proximal link assembly 254 is involved with all movements of the finger assembly 22a-22d. In other words, at least one aspect of the proximal link assembly 254 must move in order to cause any portion of the finger assembly 22a-22d to move. This feature is beneficial because it reduces complexities, reduces components, cost, weight, increases reliability, and may have other benefits.

The primary or main proximal link or first bar 254.1 is best shown in FIGS. 27 and 38-40. The main proximal link 254.1 includes: (i) partially-circular frame members or first proximal link segment 254.1.1, (ii) second proximal link segment 254.1.2, (iii) third proximal link segment 254.1.3, (iv) proximal link bridge 254.1.4, (v) medial assembly opening 254.1.5, and (vi) first and second medial link projections 254.1.6a, 254.1.6b. The partially-circular frame members segment 254.1.1 include left and right extents 254.1.1.1, 254.1.1.2 that extend from the rearmost extent of the main proximal link 254 to line S₁ shown in FIG. 39. Like partially-circular frame members segment 254.1.1, the second proximal link segment 254.1.2 also includes left and right extents 254.1.2.1, 254.1.2.2 that extend between lines S₁ and S₂ shown in FIG. 39. As shown in FIG. 39, the left and right extents 254.1.2.1, 254.1.2.2 taper inward as they extend from line S₁ to line S₂, which reduces the overall width of the link 254.1. The reduction in width is beneficial because it allows for a reduction in the width of the finger assembly 22a-22d to allow for conformal materials to aid in gripping objects. It should be understood that in other embodiments, the taper may be greater or lesser, or it may be eliminated.

Also, as shown in FIG. 39, like the second proximal link segment 254.1.2, the third proximal link segment 254.1.3 also includes left and right extents 254.1.3.1, 254.1.3.2 that extend forward from line S₂ toward the forward most extent of main proximal link or first bar 254.1. These left and right extents 254.1.3.1, 254.1.3.2 are substantially parallel to the left and right extents 254.1.1.1, 254.1.1.2, but are not aligned therewith due to the taper of the left and right extents 254.1.2.1, 254.1.2.2. In other embodiments, said left and right extents 254.1.3.1, 254.1.3.2 need not be substantially parallel and/or may be substantially aligned with other components of the main proximal link 254.1.

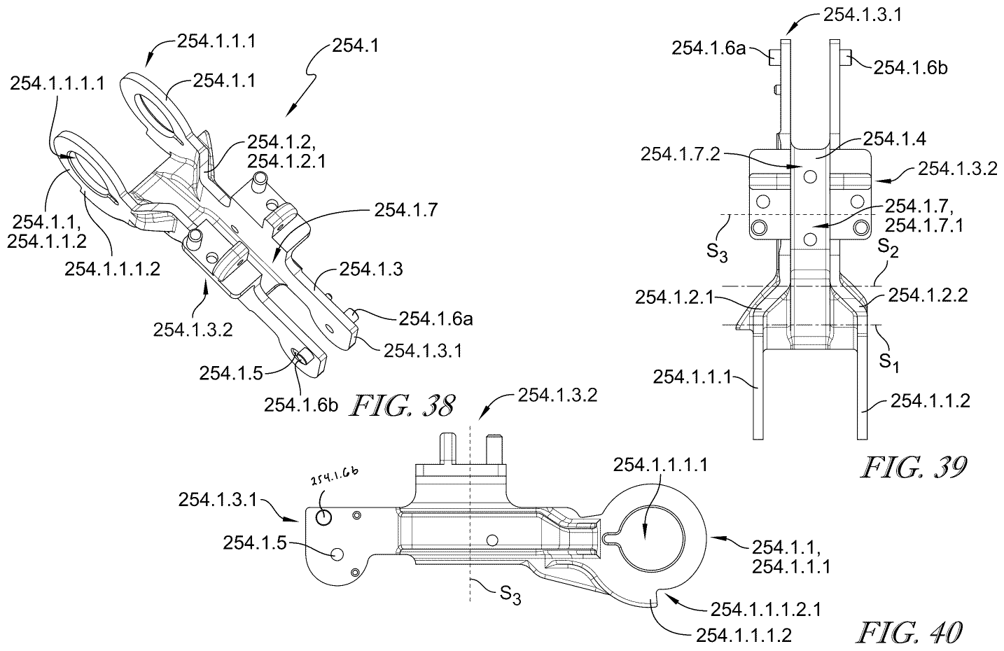

As shown in FIG. 38, the partially-circular frame members segment 254.1.1 includes a metacarpophalangeal joint coupler 254.1.1.1 that helps form a first joint or metacarpophalangeal joint MJ and includes an axle aperture 254.1.1.1.1 and stopping projection 254.1.1.1.2. As such, the first joint or metacarpophalangeal joint MJ is formed between the knuckle assembly 230 and the proximal assembly 250. The axle aperture 254.1.1.1.1 of the metacarpophalangeal joint coupler 254.1.1.1 is non-circular and is configured to receive an extent of the worm wheel interface 256 (which will be discussed later). The non-circular configuration allows helps ensure that the worm wheel interface 256 does not slip within the aperture 254.1.1.1.1, when the motor assembly 210 drives the worm drive gear 216, which turns the worm wheel 236, and whereby causing the worm drive link 254.4.1 and the proximal drive link 254.4.3 to move the primary or main proximal link or first bar 254.1. Slipping within said aperture 254.1.1.1.1 would not only cause the finger assembly 22a-22d to fail to properly move, but it would also cause the encoders and other sensors to error in knowing the finger assemblies 22a-22d location and position in space. It should be understood that other non-circular configurations of the axle aperture 254.1.1.1.1 are contemplated by this disclosure (e.g., tear-drop).

Referring to FIGS. 27, 28, 34, and 40, the stopping projection 254.1.1.1.2 is positioned in a lower extent of the partially-circular frame members segment 254.1.1. When the proximal assembly 250 is closed, curled, or in the inwardly rotated position, the stopping projection 254.1.1.1.2 includes a first limiting interface region 254.1.1.1.2.1 that is configured to interact with an extent of the knuckle frame member 232.1. It should be understood that the above described interface region 254.1.1.1.2.1 need not make contact with the described adjacent structures, and instead, a gap may be present between these structures regardless of the state of the finger assembly 22a-22d.

As shown in FIGS. 38-40, the third segment 254.1.3 of the main proximal link 254.1 includes the second limiting interface region 254.1.3.1 and housing mounting projections 254.1.3.2. The second limiting interface region 254.1.3.1 is best shown in FIGS. 23A and 38-40 and is configured to prevent the proximal assembly 250 from over-rotating or curling backward. While the second limiting interface region 254.1.3.1 is positioned on the forwardmost extent of the third segment 254.1.3, the housing mounting projections 254.1.3.2 are positioned on the uppermost point of the third segment 254.1.3 and are configured to couple to both the proximal jacket and proximal casing assemblies 252.1, 252.2 within the finger assembly 22a-22d. Other methods of preventing over-rotation and coupling the housing assembly 252 within the finger assembly 22a-22d are contemplated by this disclosure. For example, the housing assembly 252 may be configured to prevent over-rotation, while said assembly 252 may be formed from a single piece of material.

As shown in FIG. 39, the proximal bridge 254.1.4 extends between the left and right extents 254.1.3.1 and 254.1.3.2 of the third proximal link segment 254.1.3. Thus, the combination of the proximal bridge 254.1.4 and the left and right extents 254.1.3.1, 254.1.3.2 forms a U-shaped member with a proximal link recess 254.1.7. Said proximal link recess 254.1.7 includes a first portion 254.1.7.1 and a second portion 254.1.7.2. When the finger assembly 22a-22d is closed, curled, or inwardly rotated position: (i) the first portion 254.1.7.1 that extends rearward from line S₃ is configured to receive the worm drive link 254.4.1, and (ii) the second portion 254.1.7.2 that extends forward from line S₃ is configured to receive the proximal drive link 254.4.3. Finally, the medial assembly opening 254.1.5 and first and second medial link projections 254.1.6 are positioned in a forward extent of the proximal link 254.1 (i.e., forward of line S₃) and are configured to interact with the medial assembly 270.

As shown in FIG. 52, the biasing assembly 254.2 includes a biasing member 254.2.1, a first biasing coupler 254.2.2, and a second biasing coupler 254.2.3. The first biasing coupler 254.2.2 is positioned within the first portion 254.1.7.1 of the proximal link recess 254.1.7 of the main proximal link 254.1 and extends between the left and right extents 254.1.3.1, 254.1.3.2 of the third proximal link segment 254.1.3. Meanwhile, the second biasing coupler 254.2.3 is coupled to a projection that depends from the proximal drive link 254.4.3 (discussed further below). As such, one end of the biasing member 254.2.1 is coupled to the first biasing coupler 254.2.2, while a second opposed end of the biasing member 254.2.1 is coupled to the second biasing coupler 254.2.3. The biasing member 254.2.1 may be a spring (e.g., coil spring) or any other member (e.g., magnet) that can provide a biasing force on an extent of the finger assembly 22a-22d in order to control the order of closure/collapse of the components contained in said finger assembly 22a-22d.

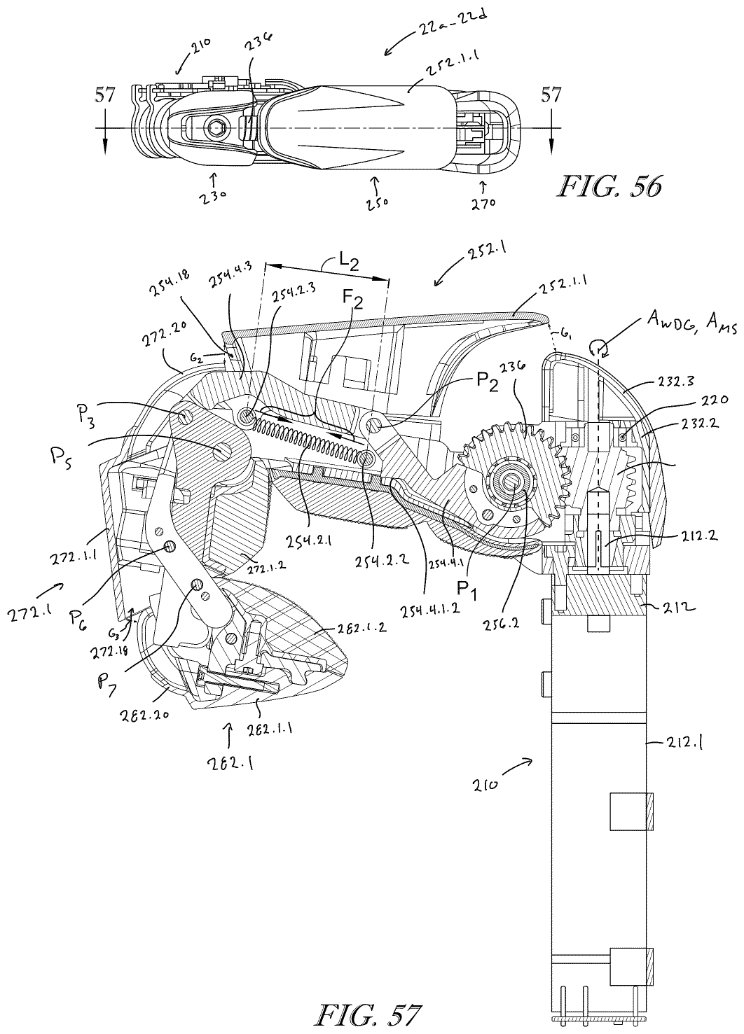

As shown in FIGS. 31 and 57, when the finger assembly 22a-22d moves from the open, uncurled, or neutral position to the closed, curled, or inwardly rotated position, the biasing member 254.2.1 moves from a first or collapsed position with a length of L₁ to a second or extended position with a length L₂. In the first or collapsed position, the biasing member 254.2.1 exerts a first biasing force F₁ that is less than a second biasing force F₂ that is exerted in the second or extended position. The biasing member 254.2.1 is designed to prevent the medial or distal assemblies 270, 280 before the proximal housing 252 has come into contact with a resistance point (e.g., an object). Once said proximal housing 252 has come into contact with a resistance point (e.g., an object), the main proximal link 254.1 and the proximal housing 252 stops moving. However, the motor assembly 210 can continue driving the worm drive gear 216 in a first direction, which turns the worm wheel 236, whereby causing the worm drive link 254.4.1 and the proximal drive link 254.4.3 to move into the proximal link recess 254.1.7 and rotation about the worm wheel axis Aww, thus forcing the biasing member 254.2.1 to expand for its original state, and therefore forces the medial and distal assemblies 270, 280 to curl inwards. The finger assembly 22a-22d can uncurl or return to its original position, if the motor assembly 210 drove driving the worm drive gear 216 in a second direction, which turns the worm wheel 236, whereby causing the worm drive link 254.4.1 and the proximal drive link 254.4.3 to move out of the proximal link recess 254.1.7, thus forcing the medial and distal assemblies 270, 280 to uncurl, therefore allowing the biasing member 254.2.1 to return to its original state, and consequently allowing the main proximal link 254.1 and the proximal housing 252 to return to their original position. In should be understood that other biasing members, structures, assemblies, or components may be used instead of the coil spring shown in the figures and in certain embodiments, that biasing assembly 254.2 may be eliminated.

As shown in in FIGS. 37 and 41-42, the drive link assembly 254.4 includes: (i) worm drive link or second bar 254.4.1, (ii) worm wheel coupler 254.4.2, (iii) proximal drive link, angled link, third bar 254.4.3, (iv) drive link coupler 254.4.4. The worm drive link 254.4.1 includes: (i) a worm wheel interface region 254.4.1.3 at a first end of the worm drive link 254.4.1, and wherein said worm wheel interface region 254.4.1.3 is configured to be positioned adjacent to and fixedly connected with the worm wheel 236, and (ii) a worm wheel coupler recess 254.4.1.4 that is positioned adjacent to the worm wheel interface region 254.4.1.3 and configured to: (a) increase the interactive surface area between the worm drive link 254.4.1 and worm wheel 236, (b) align the worm drive link 254.4.1 with the worm wheel 236, and (c) is designed to ensure that the worm wheel coupler 254.4.2 does not interfere with the movement of the worm wheel 236. It should be understood that the worm wheel coupler recess 254.4.1.4 may be omitted in other embodiments and an alternative version of the worm wheel coupler 254.4.2 may be used that lacks the clearance requirements necessitating the worm wheel coupler recess 254.4.1.4.

The worm drive link 254.4.1 includes two interface regions, namely a third limiting interface region 254.4.1.1, and a fourth limiting interface region 254.4.1.2. The third limiting interface region 254.4.1.1 extends along a rear extent of the worm drive link 254.4.1 and is configured to be positioned adjacent to an extent of the knuckle cover 232.2 of the knuckle housing assembly 232 when the finger assembly 22a-22d is in the open, uncurled, or neutral position. Meanwhile, the fourth limiting interface region 254.4.1.2 is positioned along a forward extent of the worm drive link 254.4.1 and is configured to be positioned adjacent to an extent of the main proximal link 254.1 when the finger assembly 22a-22d is in the closed, curled, or inwardly rotated position. It should be understood that the above described interface regions 254.4.1.1, 254.4.1.2 need not make contact with the described adjacent structure. Instead, a gap may be present between these structures regardless of the state of the finger assembly 22a-22d.

The proximal drive link, angled link, third bar 254.4.3 includes a worm drive link opening 254.4.3.1 at a first end and a medial link opening 254.4.3.2 at a second end. Said proximal drive link 254.4.3 is configured to be coupled between: (i) the worm drive link 254.4.1 using a drive link coupler 254.4.4 that is inserted through the worm drive link opening 254.4.3.1 and an extent of the worm drive link 254.4.1, and (ii) a main medial link 274.1 (discussed further below) using a main medial link coupler 254.4.5 that is inserted through the medial link opening 254.4.3.2 and an extent of the main medial link 274.1. The drive link coupler 254.4.4 enables the worm drive link 254.4.1 to be pivotably connected to the proximal drive link 254.4.3 in order to form a second pivot point P₂, and wherein the second pivot point P₂ is designed to move from a first location when the finger assembly 22a-22d is in open, uncurled, or neutral position (FIG. 23C) to a second location the finger assembly 22a-22d is in the closed, curled, or inwardly rotated position (FIG. 57). In comparing FIG. 23C with FIG. 57, it can be seen that the first location in further away from the palm 62 and is positioned closer to the motor assembly 210 in comparison to the second location. Said movement of the second pivot point P₂ enables the finger assembly 22a-22d to transfer the movement of the worm drive link 254.4.1 to the main medial link 274.1. As shown in FIGS. 23C and 57, this transfer of movement or energy, the angle between the worm drive link 254.4.1 and the proximal drive link 254.4.3 changes depending on the position of the finger assembly 22a-22d.

iii. Worm Wheel Interface and Proximal PCB

The worm wheel interface 256 includes first and second worm locking members 256.1a, 256.1b, along with first and second worm bearings 256.2a, 256.2b. The worm wheel assembly 256 utilizes the configuration of the locking members and bearings 256.1a, 256.1b, 256.2a, 256.2b to allow the main proximal link 254.1 to remain in a fixed position once it has come into contact with a resistance point, while the motor assembly 210 continues to drive the proximal drive link assembly 254.4 (causing movement of the medial and distal assemblies 270, 280). In other words, the bearings 256.1a, 256.1b allow the main proximal link 254.1 to stop rotating even when the worm wheel 236 continues to rotate. It should be understood that without this slippage between the main proximal link 254.1 and the worm wheel 236, the finger assembly 22a-22d could not rotate the medial and distal assemblies 270, 280 once the proximal assembly 250 came into contact with a resistance point.

The proximal PCB 258 includes a second finger encoder (e.g., magnetic, optical, capacitive, resistive, etc.) that is positioned proximate to the proximal interphalangeal joint PIJ and configured to collect medial data, wherein said medial data includes information related to the rotation of the proximal interphalangeal joint PIJ. Said medial data may use the robot system to generate a vector representation (e.g., a space embedding) indicating the state of the medial assembly 270 or the environment around the medial assembly 270. The encoder of the proximal PCB 258 may collect data upon a specific command from the robot system or periodically (e.g., between 500 times per second to every minute).

d. Medial Assembly

The medial assembly 270 is positioned between the proximal assembly 250 and the distal assembly 280 and is the second portion of the finger assembly 22a-22d configured to move relative to the palm 610. The medial assembly 270 includes: (i) a medial housing assembly 272, and (ii) a medial link assembly 274.

i. Medial Housing Assembly

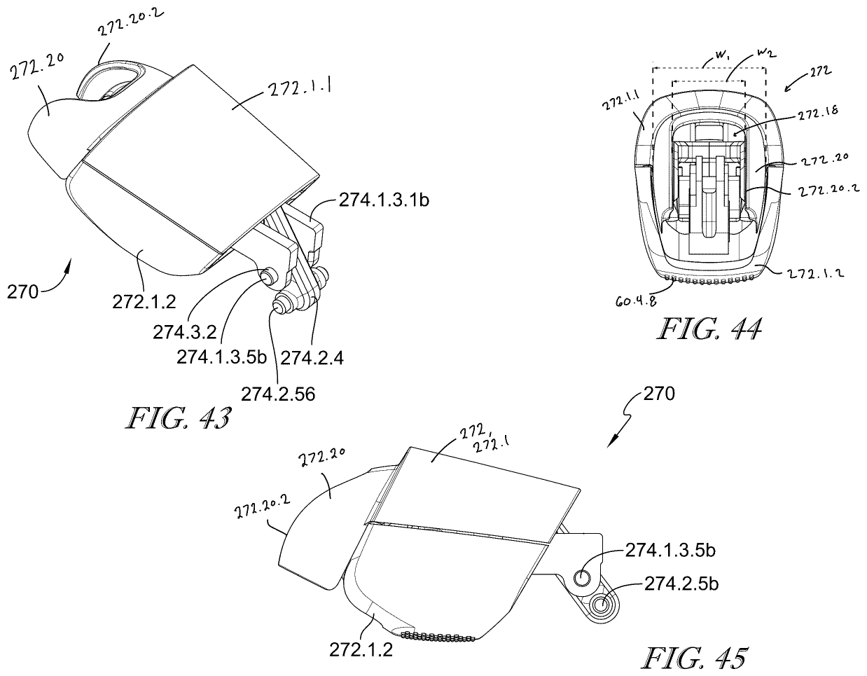

As shown in FIGS. 23A-24B, 43-45, and 57, the medial housing assembly 272 is designed to substantially surround a majority of the other components of the medial assembly 270. To achieve this, the medial housing assembly 272 forms an internal medial recess 272.18. The internal medial recess 272.18 is designed to not only surround components of the medial assembly 270, but is also designed to receive: (i) an extent of the distal assembly 280 (namely, the distal tongue 282.20), when the finger assembly 22a-22d is in the open, uncurled, or neutral position, and (ii) a lesser extent of, or none of, the distal assembly 280 (namely, the distal tongue 282.20), when the finger assembly 22a-22d is in the closed, curled, or inwardly rotated position. In other words, the medial housing assembly 272 overlies: (i) a substantial extent of the distal tongue 282.20 when the finger assembly 22a-22d is in the open, uncurled, or neutral position, and (ii) a minor extent of, or none of, the distal tongue 282.20 when the finger assembly 22a-22d is in the closed, curled, or inwardly rotated position. Stated another way, the percentage of the distal assembly 280 (namely, the distal tongue 282.20) that is positioned within the medial housing assembly 272 is reduced when the finger assembly 22a-22d moves from the open, uncurled, or neutral position to the closed, curled, or inwardly rotated position. By enabling at least a minimal extent of the distal assembly 280 (namely, the distal tongue 282.20) to be positioned within or adjacent to the medial assembly 270, the gap G₃ formed between the assemblies 270 and 280 is minimized, and wherein said minimization of said gap G₃ is beneficial because it minimizes the chance or probability that a glove or external covering can be caught or pinched between these assemblies.

As shown in FIGS. 17-26 and 43-45, the medial housing assembly 272 specifically includes: (i) a medial jacket assembly 272.1 with a top member 272.1.1 and a bottom member 272.1.2, and (ii) a medial bottom casing assembly 272.2. While the bottom member 272.1.2 is in direct contact with and underlies the medial bottom casing assembly 272.2, the finger assembly 22a-22d lacks a medial top casing assembly that is in direct contact with the top member 272.1.1. This design is advantageous because the medial bottom casing assembly 272.2 provides the bottom member 272.1.2 with additional rigidity, which enables said bottom member 272.1.2 to be made from a softer, easier-to-form, and potentially less durable material, thereby increasing the gripping capability of the end effector 10. In contrast, the top member 272.1.1 does not need to include a softer, easier-to-form, and potentially less durable material because said top member 272.1.1 is not designed to come into regular contact with objects. Additionally, even if the materials of the medial bottom casing assembly 272.2 and the bottom member 272.1.2 are the same, it may be desirable to form these components as two separate components to facilitate replicability without exposing an inner extent of the finger assembly 22a-22d. Another way of describing this beneficial configuration includes the fact that the medial jacket assembly 272.1 is configured to provide the primary external shape of the finger assembly 22a-22d, while the medial casing assembly 272.2 is configured to protect the proximal PCB 258 and provide a spacer between the medial link assembly 274 and the medial jacket assembly 272.1. Nevertheless, it should be understood that in an alternative embodiment, the bottom member 272.1.2 and the medial bottom casing assembly 272.2 may be integrally formed as a single structure.

As best shown in FIGS. 23A-24B, the top member 272.1.1 of the medial jacket assembly 272.1 includes an exterior surface back with a curvilinear extent in a first direction (namely, across the width of the finger assembly 22a-22d), and the bottom member 272.1.2 of the medial jacket assembly 272.1 includes an exterior palm surface that is curvilinear extent in the first direction (namely, across the width of the finger assembly 22a-22d) and a second direction (namely, across the length of the finger assembly 22a-22d). The curvilinear extent in the first direction helps ensure that the finger assembly 22a-22d has rounded edges to help with grasping objects, while the curvilinear extent in the second direction helps ensure that the finger can curl inward. Additionally and as discussed above, the top member 272.1.1 of the medial jacket assembly 272.1 includes a rearwardly extending medial tongue 272.20. The medial tongue 272.20 has an arched shape with a curvilinear rear surface 272.20.2, wherein the width of said medial tongue 272.20 is reduced from a first or front width W₁ to a second or rear width W₂. As such, the medial tongue 272.20 includes curvilinear extents in at least two directions. As discussed above, the medial tongue 272.20 is designed to be positioned within or adjacent to proximal housing assembly 252 and configured to minimize the gap G₂ that is formed between assemblies 250 and 270. It should be understood that in an alternative embodiment, the medial tongue 272.20 may be omitted.

As discussed above, the medial housing assembly 272 may be: (i) made from the same materials as the housing assembly 60, (ii) made from materials that differ from the materials used in the housing assembly 60, and/or (iii) may include silicon, plastic (e.g., may include a polymer composition), carbon composite, or metal, a combination of these materials, and/or any other know material used in robot systems. Alternatively, the medial housing assembly 272 may include additional components or layers (e.g., between three and an nth). It should be also be understood in alternative embodiments that the medial jacket assembly 272.1 and the medial casing assembly 272.2 may be combined into a single component and/or additional exterior members may be added to the end effector 10/finger assembly 22a-22d.

ii. Medial Link Assembly 274

As shown in FIG. 40, the medial link assembly 274 includes: (i) a primary or main medial link or fourth bar 274.1, (ii) a medial drive link or fifth bar 274.2, and (iii) a main/drive link couplers or sixth bar 274.3a, 274.3b. The medial link assembly 274 is involved with a majority of the movements of the finger assembly 22a-22d. While the proximal assembly 250 could move without causing a positional change between said proximal assembly 250 and the medial assembly 270, the distal assembly 280 cannot move without causing a positional change between said distal assembly 280 and the medial assembly 270. Because most movements of the end effector 10 involve movement of the medial assembly 270 relative to the proximal assembly 250 and/or distal assembly 280, said medial assembly 270 is involved with a majority of the movements of the finger assembly 22a-22d. As discussed above, this is contrast to conventional end effectors and/or conventional fingers and is beneficial because it reduces complexities, reduces components, increases reliability, and may afford other benefits.

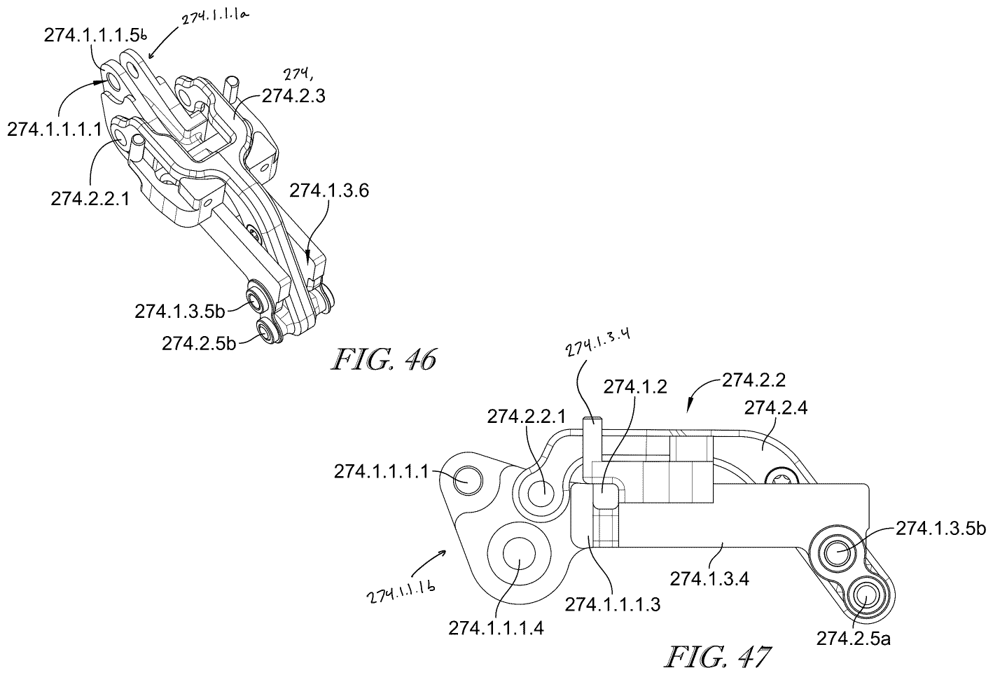

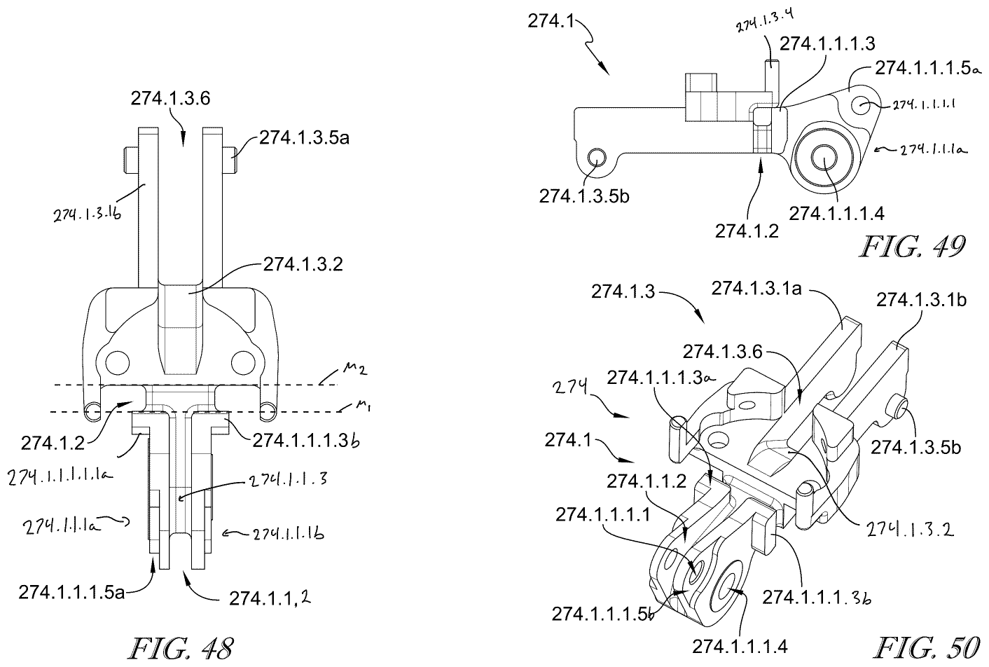

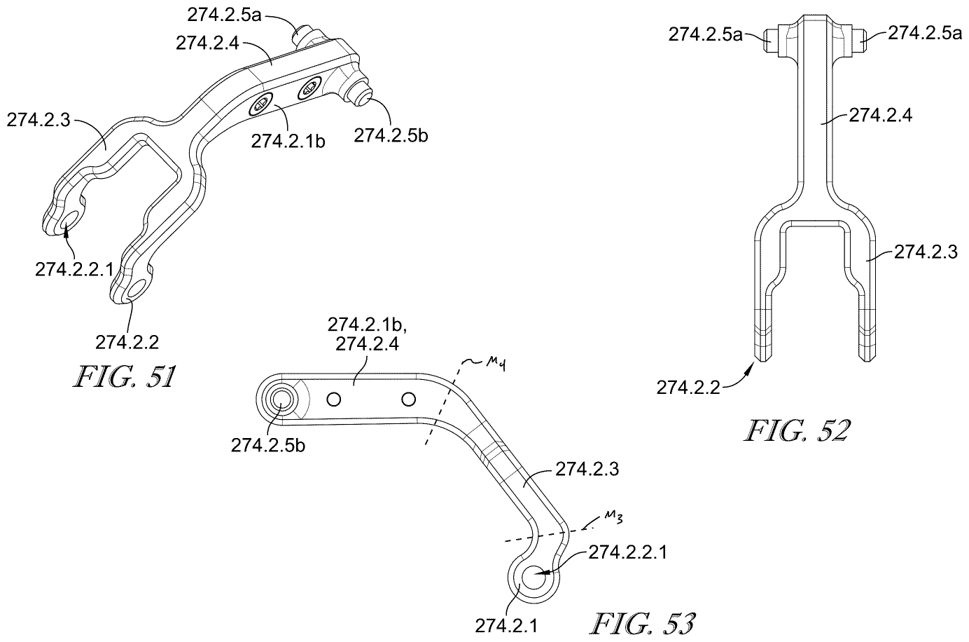

The primary or main medial link or fourth bar 274.1 is best shown in FIGS. 46-53. The main medial link 274.1 helps form a second or proximal interphalangeal joint PIJ that is positioned between the proximal assembly 250 and the medial assembly 270. The main medial link 274.1 is designed to be pivotably connected to both the proximal link 254.1 and the proximal drive link 254.4.3 and includes three integrally formed components, wherein said components include: (i) proximal interphalangeal joint coupler 274.1.1 that extends rearward from line M₁, (ii) medial link neck or biasing neck 274.1.2 that extends between lines M₁ and M₂, and (iii) medial link extension 274.1.3 that extends forward from M₂. The first component of the main medial link 274.1 is the proximal interphalangeal joint coupler 274.1.1 and is comprised of: (i) a first and second partially-triangular frame members 274.1.1.1a, 274.1.1.1b, (ii) a first medial link or interphalangeal joint recesses 274.1.1.2, and (iii) medial link bridge 274.1.1.3 that couples the first and second partially-triangular frame members 274.1.1.1a, 274.1.1.1b to one another. The first and second partially-triangular frame members 274.1.1.1a, 274.1.1.1b are the rearmost extent of the main medial link 274.1 and have: (i) a proximal drive link aperture 274.1.1.1.1, (ii) a drive link assembly recesses 274.1.1.2, (iii) first and second limiting projections 274.1.1.1.3a, 274.1.1.1.3b, and (vi) a proximal main link aperture 274.1.1.1.4.

As discussed above, the first and second partially-triangular frame members 274.1.1.1a, 274.1.1.1b of the proximal interphalangeal joint coupler 274.1.1 of the main medial link 274.1 include the proximal drive link aperture 274.1.1.1.1. In particular, the proximal drive link aperture 274.1.1.1.1 is formed in the drive link assembly recesses 274.1.1.1.5a, 274.1.1.1.5b and is configured to receive an extent of a securement member 274.1.1.1.10 that pivotally connects the proximal drive link assembly 254.4 to the main medial link 274.1. Pivotally connecting the proximal drive link assembly 254.4 to the main medial link 274.1 forms a third pivot point P₃, which further enables the transfer of energy from the motor assembly 210 to the distal assembly 280. Like a majority of the pivot points, the third pivot point P₃ is configured to move from a first location to a second location when the finger assembly 22a-22d moves from the open, uncurled, or neutral position to the closed, curled, or inwardly rotated position. When comparing FIG. 31 to FIG. 57, the first location is positioned rearward and above or towards the back of the end effector 10 in comparison to the second location.

The proximal link opening 274.1.1.1.4 that is formed in the first and second partially-triangular frame members 274.1.1.1a, 274.1.1.1b and is positioned forward and below the proximal drive link aperture 274.1.1.1.1. In particular, the proximal link opening 274.1.1.1.4 pivotally couples the main proximal link 254.1 to the main medial link 274.1 using the medial assembly coupler 254.3, and whereby creating a fifth pivot point P₅. Unlike a majority of the other pivot points, the fifth pivot point P₅ is semi-fixed because: (i) unlike the first pivot point P₁, it moves when the proximal assembly 250 moves, and (ii) unlike the second pivot point P₂ or the third pivot point P₃, it cannot move relative to the proximal assembly 250. Thus, the movement of the fifth pivot point P₅ is between the movement capabilities of the fixed and non-fixed pivot points and therefore is semi-fixed. Said fifth pivot point P₅ needs to be fixed relative to the proximal assembly 250 to enable the proximal drive link assembly 254.4 to force the medial assembly 270 around a pivot point P₅ or medial axis AM. Said medial axis AM is parallel with the worm wheel axis Aww, but is perpendicular (in one direction) to both the motor shaft axis A_{MS} and the worm drive gear axis A_{WDG}.

The first and second limiting projections 274.1.1.1.3a, 274.1.1.3b of the proximal interphalangeal joint coupler 274.1.1 have a wedge configuration that forms the sixth limiting interface regions 274.1.1.1.1.1a, 274.1.1.1.1.1b. Said sixth limiting interface regions 274.1.1.1.1.1a and 274.1.1.1.1.1b are positioned adjacent to the medial drive link 274.2 and help ensure that the medial assembly 274 does not over-rotate or curl backward. Finally, the combination of the first and second partially-triangular frame members 274.1.1.1a, 274.1.1.1b and the medial link bridge 274.1.1.3 form a U-shaped extent, which said first medial link or interphalangeal joint recess 274.1.1.2 is formed therebetween. Said interphalangeal joint recess 274.1.1.2 is designed to receive an extent of the proximal link assembly 254, and specifically an second end of the proximal drive link 254.4.3. The interlocking, stacking, and/or overlying nature of these connections will be discussed in greater detail below.

The medial link neck or biasing neck 274.1.2 extends forward from the first and second partially-triangular frame members 274.1.1.1a, 274.1.1.1b and couples the first and second partially-triangular frame members 274.1.1.1a, 274.1.1.1b to a medial link extension 274.1.3. The medial link extension 274.1.3 is configured to be coupled to the medial housing assembly 272 and provides a majority of the structural body of said main medial link 274.1. The medial link extension 274.1.3 includes: (i) a medial link frame member 274.1.3.1, (ii) a medial link sloped member 274.1.3.2, (iii) a housing mounting projections 274.1.3.4, and (iv) medial drive link projections 274.1.3.5a, 274.1.3.5b. The combination of the frame members 274.1.3.1, sloped member 274.1.3.2, and frontal member 274.1.3.3 form a medial link recess or truncated rectangular-shaped recess 274.1.3.6 in the middle of the medial link extension 274.1.3. This medial link recess or truncated rectangular-shaped recess 274.1.3.6 is configured to receive an extent of the medial drive link 274.2 and allow sufficient clearance for the movement of the medial drive link 274.2 relative to the medial link extension 274.1.3. Meanwhile, the housing mounting projections 274.1.3.4 are positioned on the uppermost point of the medial link frame member 274.1.3.1 and are configured to couple both the medial jacket and medial casing assemblies 272.1, 272.2 to the main medial link 274.1.

The medial drive link projections 274.1.3.5a, 274.1.3.5b extend from the sides of the medial link extension 274.1.3 and are configured to be positioned within the distal housing assembly 282. Like the fifth pivot point P₅, the sixth pivot point P₆ is semi-fixed because: (i) unlike the first pivot point P₁, it moves when the medial assembly 270 moves, and (ii) unlike the second pivot point P₂ or the third pivot point P₃, it cannot move relative to the medial assembly 270. Thus, the movement of the sixth pivot point P₆ is between the movement capabilities of the fixed and non-fixed pivot points and therefore is semi-fixed. Said sixth pivot point P₆ needs to be fixed relative to the medial assembly 270 to enable the movement of the medial drive link 274.2 to force the distal assembly 280 around a pivot point P₆ or distal axis Ap. Said distal axis A_{D} is parallel with the medical axis AM and the worm wheel axis Aww, but is perpendicular (in one direction) to both the motor shaft axis A_{MS} and the worm drive gear axis A_{WDG}.

The medial drive link, or fifth bar 274.2 is best shown in FIGS. 26-31 and 46-53. The medial drive link 274.2 includes: (i) an angled segment 274.2.2 forward from a rearmost point of the medial drive link 274.2 to line M₃, (iii) lateral segment 274.2.3 extending from line M₃ to M₄, and (iv) the elongated segment 274.2.4 extending forward from line M₄. This complex geometry can be best seen in FIG. 53. The angled segment 274.2.2 of the medial drive link 274.2 includes main proximal link opening 274.2.2.1 that are configured to receive first and second medial link projections 254.1.6a, 254.1.6b to form the fourth pivot point P₄. In other words, the medial drive link 274.2 is pivotably connected to the medial link 274.1: (i) on a first side of a sagittal plane extending through the finger assembly via opening 274.2.2.1 and a projection 254.1.6a, and (ii) on a second side of a sagittal plane extending through the finger assembly via opening 274.2.2.1 and a projection 254.1.6b. Like the fifth pivot point P₅ and the sixth pivot point P₆, the fourth pivot point P₄ is semi-fixed because: (i) unlike the first pivot point P₁, it moves when the proximal assembly 250 moves, and (ii) unlike the second pivot point P₂ or the third pivot point P₃, it cannot move relative to the proximal assembly 250. Thus, the movement of the fourth pivot point P₄ is between the movement capabilities of the fixed and non-fixed pivot points and therefore is semi-fixed. Said fourth pivot point P₄ needs to be fixed relative to the proximal assembly 250 to enable the medial drive link 274.2 to rotate around the fourth pivot point P₄.

The main/drive link couplers or sixth bar 274.3a, 274.3b is secured within an extent of the distal housing assembly 282 and is configured to couple the main medial link 274.1 and the medial drive link 274.2 to one another, while being positioned within an extent of the distal assembly 280. The main/drive link couplers 274.3a, 274.3b.3 includes: (i) a main body 274.3.1 with a first aperture or upper coupler aperture 274.3.1.1, and a second aperture or lower coupler aperture 274.3.1.2, and (ii) first and second flanges 274.3.2a, 274.3.2b. While the flanges 274.3.2a, 274.3.2b surround the apertures 274.3.1.1, 274.3.1.2: (i) the apertures 274.3.1.1 are configured to receive the medial drive link projections 274.1.3.5a, 274.1.3.5b, and (ii) the apertures 274.3.1.2 are configured to receive the left and right portion couplers 274.2.5a, 274.2.5b. It should be understood that the main/drive link couplers 274.3a, 274.3b may be eliminated in certain embodiments, and instead, the main medial link 274.1 and the medial drive link 274.2 may be coupled to one another differently.

As shown in the Figures, the link assemblies 254, 274, and 284 have interlocking, overlapping, underlying, and/or stacking configuration. This complex configuration helps increase the durability of the finger assembly 22a-22d. In particular, the worm drive link 254.4.1 includes a forked second end that is designed to receive an extent of the first end of the proximal drive link 254.4.3. Likewise, the main medial link 274.1 also includes a forked rear end that is formed by the first and second partially-triangular frame members 274.1.1.1a, 274.1.1.1b that is designed to receive a second end of the proximal drive link 254.4.3. As such, both ends of the proximal drive link 254.4.3 is centered within a fork-like recess formed in the adjacent links. The links also are designed to position the primary proximal link 254.1 outside of the worm wheel 236 and an extent of the medial primary 274.1. This not only provides the finger assembly 22a-22d with rigidity, but it also allows the finger assembly 22a-22d to narrow as it extends from the base of the finger assembly 22a-22d to the tip of the said finger assembly 22a-22d. This configuration also allows for the second end of the proximal drive link 254.4.3 to be positioned within the main medial link 274.1, which is also positioned within the primary proximal link 254.1. The medial drive link 274.2 not only includes an extent that is positioned outside of the main medial link 274.1, but it also includes an extent that is positioned within the main medial link 274.1. And finally, an extent of the distal assembly 280 is positioned outside of the main medial link 274.1. In sum, each of the links is supported on two sides, and therefore, said links are not solely supported on a single side. Nevertheless, in an alternative embodiment, the links could be supported on a single side.

Based on the above disclosure, as best shown in FIG. 57, and when the finger assembly 22a-22d is in the closed, curled, or in the inwardly rotated position, the proximal link recess 254.1.7 is designed to receive a substantial extent of the proximal link assembly 254. Additionally, the medial link recess or truncated rectangular-shaped recess 274.1.3.6 is designed to receive differing extents of the medial drive link 274.2 based on the position of the finger assembly 22a-22d. Further, the interphalangeal joint recesses 274.1.1.2 is designed to receive the second end of the proximal link assembly 254. Based on this disclosure, it should be understood that the

e. Distal Assembly 280

The distal assembly 280 is positioned forward of the medial assembly 270 and is the third portion of the finger assembly 22a-22d configured to move relative to the palm 610. The distal assembly 280 includes: (i) a distal housing assembly 282, and (ii) a distal link assembly 284.

i. Distal Housing Assembly 282

As shown in FIGS. 23A-24B, 43-45, and 57, the distal housing assembly 282 is designed to substantially surround a majority of the other components of the distal assembly 280. To achieve this, the distal housing assembly 282 forms an internal distal recess 282.18 and specifically includes: (i) a distal jacket assembly 282.1 with a top member 282.1.1 and a bottom member 282.1.2, and (ii) a distal bottom casing assembly 282.2. While the bottom member 282.1.2 is in direct contact with and underlies the distal bottom casing assembly 282.2, the finger assembly 22a-22d lacks a distal top casing assembly that is in direct contact with the top member 282.1.1. This design is advantageous because the distal bottom casing assembly 282.2 provides the bottom member 282.1.2 with additional rigidity, which enables said bottom member 282.1.2 to be made from a softer, easier-to-form, and potentially less durable material, thereby increasing the gripping capability of the end effector 10. In contrast, the top member 282.1.1 does not need to include a softer, easier-to-form, and potentially less durable material because said top member 282.1.1 is not designed to come into regular contact with objects. Additionally, even if the materials of the distal bottom casing assembly 282.2 and the bottom member 282.1.2 are the same, it may be desirable to form these components as two separate components to facilitate replicability without exposing an inner extent of the finger assembly 22a-22d. Another way of describing this beneficial configuration includes the fact that the distal jacket assembly 282.1 is configured to provide the primary external shape of the finger assembly 22a-22d, while the distal casing assembly 282.2 is configured to protect the distal link assembly 284. Nevertheless, it should be understood that in an alternative embodiment, the bottom member 282.1.2 and the distal bottom casing assembly 282.2 may be integrally formed as a single structure.

As best shown in FIGS. 23A-24B, the top member 282.1.1 of the distal jacket assembly 282.1 includes an exterior surface back with a curvilinear extent in a first direction (namely, across the width of the finger assembly 22a-22d), and the bottom member 282.1.2 of the distal jacket assembly 282.1 includes an exterior palm surface that is curvilinear extent in the first direction (namely, across the width of the finger assembly 22a-22d) and a second direction (namely, across the length of the finger assembly 22a-22d). The curvilinear extent in the first direction helps ensure that the finger assembly 22a-22d has rounded edges to help with grasping objects, while the curvilinear extent in the second direction helps ensure that the finger can curl inward. Additionally and as discussed above, the top member 282.1.1 of the distal jacket assembly 282.1 includes a rearwardly extending distal tongue 282.20. The distal tongue 282.20 has an arched shape with a curvilinear rear surface 282.20.2, wherein the width of said distal tongue 282.20 is reduced from a first or front width to a second or rear width. As such, the distal tongue 282.20 includes curvilinear extents in at least two directions. As discussed above, the distal tongue 282.20 is designed to be positioned within or adjacent to medial housing assembly 272 and configured to minimize the gap G₃ that is formed between assemblies 270 and 280. It should be understood that in an alternative embodiment, the distal tongue 282.20 may be omitted.

As discussed above, the distal housing assembly 282 may be: (i) made from the same materials as the housing assembly 60, (ii) made from materials that differ from the materials used in the housing assembly 60, and/or (iii) may include silicon, plastic (e.g., may include a polymer composition), carbon composite, or metal, a combination of these materials, and/or any other know material used in robot systems. Alternatively, the distal housing assembly 282 may include additional components or layers (e.g., between three and an nth). It should be also be understood in alternative embodiments that the distal jacket assembly 282.1 and the distal casing assembly 282.2 may be combined into a single component and/or additional exterior members may be added to the end effector 10/finger assembly 22a-22d.

ii. Distal Link Assembly 284

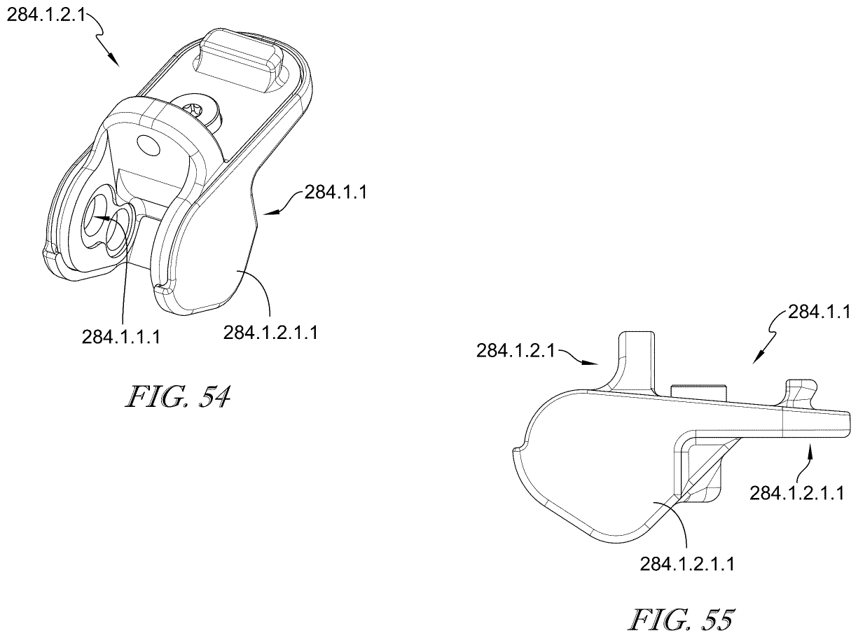

As shown in FIGS. 54-55, the distal link assembly 284 includes primary or main distal link or seventh bar 284.1 that helps form a third joint or distal interphalangeal joint 284.1.1, and includes a tip assembly 284.1.2. Said third joint or distal interphalangeal joint 284.1.1 is formed between the medial assembly 270 and the distal assembly 280. The distal link assembly 284 is involved in the least number of movements of the finger assembly 22a-22d compared to the number of movements involving the proximal and medial assemblies 250, 270. As best shown in FIGS. 54-55, the third joint 284.1.1 includes first and second coupler recesses 284.1.1.1a, 284.1.1.1b, while the tip assembly 284.1.2 has: (i) a tip body 284.1.2.1 with first and second portions 284.1.2.1.1a, 284.1.2.1.1b, and internal projections 284.1.2.1.2, and (ii) tip coupler 284.1.2.2 for coupling the first and second portions 284.1.2.1.1a, 284.1.2.1.1b of the tip body 284.1.2.1 to one another.

### D. Industrial Application

While the disclosure shows illustrative embodiments of a robot (in particular, a humanoid robot), it should be understood that embodiments are designed to be examples of the principles of the disclosed assemblies, methods and systems, and are not intended to limit the broad aspects of the disclosed concepts to the embodiments illustrated. As will be realized, the disclosed robot, and its functionality and methods of operation, are capable of other and different configurations and several details are capable of being modified all without departing from the scope of the disclosed methods and systems. For example, one or more of the disclosed embodiments, in part or whole, may be combined with a disclosed assembly, method and system. As such, one or more steps from the diagrams or components in the Figures may be selectively omitted and/or combined consistent with the disclosed assemblies, methods and systems. Additionally, one or more steps from the arrangement of components may be omitted or performed in a different order. Accordingly, the drawings, diagrams, and detailed description are to be regarded as illustrative in nature, not restrictive or limiting, of the said humanoid robot.

While the above-described robot is designed as a head for use with a general-purpose humanoid robot, it should be understood that its assemblies, components, learning capabilities, and/or kinematic capabilities may be used with other robots. Examples of other robots include: articulated robot (e.g., an arm having two, six, or ten degrees of freedom, etc.), a cartesian robot (e.g., rectilinear or gantry robots, robots having three prismatic joints, etc.), Selective Compliance Assembly Robot Arm (SCARA) robots (e.g., with a donut shaped work envelope, with two parallel joints that provide compliance in one selected plane, with rotary shafts positioned vertically, with an end effector attached to an arm, etc.), delta robots (e.g., parallel link robots with parallel joint linkages connected with a common base, having direct control of each joint over the end effector, which may be used for pick-and-place or product transfer applications, etc.), polar robots (e.g., with a twisting joint connecting the arm with the base and a combination of two rotary joints and one linear joint connecting the links, having a centrally pivoting shaft and an extendable rotating arm, spherical robots, etc.), cylindrical robots (e.g., with at least one rotary joint at the base and at least one prismatic joint connecting the links, with a pivoting shaft and extendable arm that moves vertically and by sliding, with a cylindrical configuration that offers vertical and horizontal linear movement along with rotary movement about the vertical axis, etc.), self-driving car, a kitchen appliance, construction equipment, or a variety of other types of robot systems. The robot system may include one or more sensors (e.g., cameras, temperature, pressure, force, inductive or capacitive touch), motors (e.g., servo motors and stepper motors), actuators, biasing members, encoders, housing, or any other component known in the art that is used in connection with robot systems. Likewise, the robot system may omit one or more sensors (e.g., cameras, temperature, pressure, force, inductive or capacitive touch), motors (e.g., servo motors and stepper motors), actuators, biasing members, encoders, housing, or any other component known in the art that is used in connection with robot systems.

In other embodiments, other configurations and/or components may be utilized. As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. The server functions may be implemented in a distributed fashion on a number of similar platforms, to distribute the processing load.

Hence, aspects of the disclosed methods and systems outlined above may be embodied in programming. Program aspects of the technology may be thought of as “products” or “articles of manufacture” typically in the form of executable code and/or associated data that is carried on or embodied in a type of machine-readable medium. “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

A machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the disclosed methods and systems. Volatile storage media include dynamic memory, such as the main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is to be understood that the invention is not limited to the exact details of construction, operation, exact materials or embodiments shown and described, as obvious modifications and equivalents will be apparent to one skilled in the art. While the specific embodiments have been illustrated and described, numerous modifications come to mind without significantly departing from the spirit of the invention, and the scope of protection is only limited by the scope of the accompanying Claims. It should also be understood that substantially utilized herein means a deviation less than 15% and preferably less than 5%. It should also be understood that other configuration or arrangements of the above-described components is contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

In this Application, to the extent any U.S. patents, U.S. patent applications, or other materials (e.g., articles) have been incorporated by reference, the text of such materials is only incorporated by reference to the extent that they do not conflict with materials, statements and drawings set forth herein. In the event of such conflict, the text of the present document controls, and terms in this document should not be given a narrower reading in virtue of the way in which those terms are used in other materials incorporated by reference. It should also be understood that structures and/or features not directly associated with a robot cannot be adopted or implemented into the disclosed humanoid robot without careful analysis and verification of the complex realities of designing, testing, manufacturing, and certifying a robot for completion of usable work nearby and/or around humans. Theoretical designs that attempt to implement such modifications from non-robotic structures and/or features are insufficient (and in some instances, woefully insufficient) because they amount to mere design exercises that are not tethered to the complex realities of successfully designing, manufacturing and testing a robot.

1. An end effector for a humanoid robot, the end effector comprising:
a frame;
a finger assembly removably connected to the frame, the finger assembly comprising:
a worm drive link;
a proximal drive link pivotably coupled to the worm drive link;
a proximal link defining a proximal link recess configured to selectively receive at least a portion of the worm drive link and at least a portion of the main proximal drive link therein;
a medial link pivotably connected to both the proximal link and the proximal drive link and including a medial link recess configured to receive an extent of the medial drive link; and
a medial drive link pivotably connected to the medial link by at least one first pivotable coupling located on a first side of a sagittal plane extending through the finger assembly and at least one second pivotable coupling located on a second side of the sagittal plane.

2. The end effector of claim 1, wherein the finger assembly lacks a mechanical cable configured to actuate any component of the finger assembly.

3. The end effector of claim 1, wherein the finger assembly further comprises:
a motor including a motor shaft;
a worm drive gear coupled to the motor shaft;
a worm wheel in geared engagement with the worm drive gear and fixedly connected to the worm drive link; and
a proximal drive link pivotably connected to the worm drive link and configured to move in response to rotation of the worm drive link.

4. The end effector of claim 1, the finger assembly further comprising:
a medial housing assembly having an internal cavity;
a distal housing assembly including: (i) a rear external surface with a first end positioned adjacent the medial housing assembly when the finger assembly is in an open position, and (ii) a tongue that extends towards the proximal link assembly and has an upper surface that is offset inwardly from the rear external surface;
wherein, when the finger assembly is in the open position, a substantial majority of the tongue is positioned within the internal cavity of the medial housing assembly.

5. The end effector of claim 1, wherein the finger assembly lacks both a pressure sensor and a force sensor, but includes a textile covering.

6. The end effector of claim 1, wherein the finger assembly further comprises a single electric motor, a worm drive, and a worm wheel configured to actuate the worm drive link.

7. The end effector of claim 1, wherein the finger assembly further comprises a biasing member having a first extent connected to the proximal link and a second extent connected to the proximal drive link, and wherein the single biasing member is configured to bias the proximal drive link toward an uncurled position.

8. The end effector of claim 1, wherein the finger assembly further includes:
a knuckle positioned adjacent to the proximal assembly;
a proximal assembly that includes the worm drive link, proximal drive link, and the proximal link;
a medial assembly that includes the medial drive link and medial link;
a distal assembly positioned adjacent to the medial assembly;
a metacarpophalangeal joint formed between the knuckle and the proximal assembly;
a proximal finger interphalangeal joint formed between the proximal assembly and the medial assembly; and
a distal finger interphalangeal joint formed between the medial assembly and the distal assembly.

9. The end effector of claim 8, further comprising:
a first finger encoder positioned proximate to the metacarpophalangeal joint and configured to collect data related to rotation of the metacarpophalangeal joint; and
a second finger encoder positioned proximate to the proximal finger interphalangeal joint and configured to collect data related to rotation of the proximal finger interphalangeal joint.

10. An end effector for a humanoid robot, the end effector comprising:
a frame;
four finger assemblies, wherein each finger assembly of the four finger assemblies are substantially identical to every other finger assembly of the four finger assemblies, and wherein each finger assembly of the four finger assemblies is removably connected to the frame at a respective point;
wherein all of the finger assemblies of the four finger assemblies are located substantially in a single plane;
wherein each finger assembly of the four finger assemblies is angularly offset within the single plane with respect to every other finger assembly of the four finger assemblies;
wherein the respective points of connection of the four fingers assemblies to the frame are not co-linear; and
wherein each finger assembly of the four finger assemblies lacks a mechanical cable configured to actuate any component of the finger assembly.

11. The end effector of claim 10, wherein each finger assembly of the four finger assemblies comprises:
a worm drive link;
a proximal drive link pivotably coupled to the worm drive link;
a proximal link defining a proximal link recess configured to selectively receive at least a portion of the worm drive link and at least a portion of the main proximal drive link therein;
a medial drive link pivotably connected to a medial link by at least one first pivotable coupling located on a first side of a sagittal plane extending through the finger assembly and at least one second pivotable coupling located on a second side of the sagittal plane; and
a medial link pivotably connected to both the proximal link and the proximal drive link and including a medial link recess configured to receive an extent of the medial drive link.

14. The end effector of claim 10, wherein each finger assembly of the four finger assemblies only have a single electric motor and include a textile covering.

15. The end effector of claim 10, wherein each finger assembly of the four finger assemblies is configured to operable independently of every other finger assembly of the four finger assemblies and does not include a force sensor.

16. The end effector of claim 10, wherein at least one of the four finger assemblies includes: (i) a proximal housing assembly with an internal proximal recess, and (ii) a medial housing assembly includes a tongue that is positioned within the internal proximal recess of the proximal housing assembly, when the at least one finger assembly is in an uncurled position.

17. The end effector of claim 10, wherein at least one of the four finger assemblies includes a proximal housing assembly having: (i) an exterior surface with a curvilinear extent in a first direction, and (ii) an interior surface that is curvilinear extent in the first direction and a second direction, and wherein the interior surface includes a plurality of projections.

18. The end effector of claim 10, wherein at least one of the four finger assemblies include a textile that covers that surrounds an extent of said finger assembly.

19. An end effector for a humanoid robot, the end effector comprising:
a frame;
a plurality of finger assemblies removably connected to the frame, each finger assembly of the plurality of finger assemblies comprising:
a motor assembly including: (i) a motor having a motor housing, and (ii) a motor shaft having a motor shaft axis, and wherein the motor shaft is configured to rotate about said motor shaft axis;
a worm drive gear coupled to the motor shaft and configured for rotation about: (i) the motor shaft axis, and (ii) a worm drive gear axis, and wherein the motor shaft axis and the worm drive gear axis are coaxial;
a worm wheel in geared engagement with the worm drive gear and configured for rotation about a worm wheel axis in response to rotation of the worm drive gear, and wherein the worm wheel axis is perpendicular to the worm drive gear axis;
a worm drive link having a first end and a second end, and wherein the first end of the worm drive link fixedly connected to the worm wheel so that the worm drive link is configured for rotation about the worm wheel axis in response to rotation of the worm wheel about the worm wheel axis;
a proximal drive link having a first end and a second end, and wherein the first end of the proximal drive link pivotably connected to the second end of the worm drive link; and
a biasing member configured to bias an extent of the proximal drive link toward a first location, and wherein the extent of the proximal drive link is in the first location when the finger assembly is in an uncurled position.

20. The end effector of claim 19, wherein each finger assembly of the plurality of finger assemblies lacks a mechanical cable configured to actuate any component of the finger assembly, and includes a textile covering.

21. The end effector of claim 20, wherein each finger assembly of the plurality of finger assemblies is configured to be swappable with every other finger assembly of the plurality of finger assemblies.

22. The end effector of claim 19, wherein a finger assembly of the plurality of finger assemblies includes: (i) a proximal housing assembly with an internal proximal recess, and (ii) a medial housing assembly includes a tongue;
wherein said tongue is positioned within the internal proximal recess of the proximal housing assembly, when the finger assembly is in the uncurled position; and
wherein said tongue is not positioned within the internal proximal recess of the proximal housing assembly, when the finger assembly is in a curled position.

23. The end effector of claim 19, wherein a finger assembly of the plurality of finger assemblies includes further includes:
a knuckle positioned adjacent to the proximal assembly;
a proximal assembly that includes the worm drive link, proximal drive link and the proximal link;
a metacarpophalangeal joint formed between the knuckle and the proximal assembly; and
a first finger encoder configured to collect data related to rotation of the metacarpophalangeal joint.

24. The end effector of claim 19, further comprising a medial link pivotably connected to both the proximal link and the proximal drive link and including a medial link recess configured to receive an extent of the medial drive link; and
a medial drive link pivotably connected to a medial link by at least one first pivotable coupling located on a first side of a sagittal plane extending through the finger assembly and at least one second pivotable coupling located on a second side of the sagittal plane.
